(19) United States
(12) Patent Application Publication
(10) Pub. No.: US 2009/0257345 A1
(43) Pub. Date: Oct. 15, 2009

(54) APPARATUS, METHOD AND COMPUTER PROGRAM PRODUCT FOR PROVIDING SELF ADAPTING TRANSPORT OF PUBLIC SWITCHED TELEPHONE NETWORK (PSTN) CIRCUITS OVER A WIRELESS NETWORK

(75) Inventor: Graham King, Clifton, VA (US)

Correspondence Address: VENABLE LLP, P.O. BOX 34385, WASHINGTON, DC, 20043-9998, US

(73) Assignee: NSGDatacom, Inc., Chantilly, VA (US)

(21) Appl. No.: 12/270,697

(22) Filed: Nov. 13, 2008

Related U.S. Application Data
(63) Continuation-in-part of application No. 11/952,818, filed on Dec. 7, 2007.

(51) Int. Cl. H04J 1/16; H04L 12/66; H04L 12/26; H04J 3/22

(52) U.S. Cl. 370/216; 370/352; 370/241; 370/465

(57) ABSTRACT

An adaptive telecommunications system for transporting communication traffic over a network comprising a means for transmitting communication traffic between a plurality of devices through a network, monitoring the communication traffic between the plurality of devices, and a adaptively changing the mode of operation either before and/or during a call, based on at least one of instantaneous network changes, connection type characteristics, and type of communication traffic. The devices attached to the network may consist of, for example, a fax machine, phone, mobile phone, public branch network exchange, a computer, or a switch. The traffic traveling across the system, voice, fax, or data, for example, may be compressed and/or restricted based on the type of traffic. The system may fully replace the existing PSTN circuits or may be used for overflow when the existing PSTN circuits are at near or full capacity.

### CROSS REFERENCE TO RELATED APPLICATIONS

The present invention is a continuation-in-part of U.S. patent application Ser. No. 11/952,818, filed Dec. 7, 2007, entitled, “Apparatus, Method and Computer Program Product For Providing Automated Backup to TDM Network Connections Over an IP Network,” to King, of common assignee to the present invention, the contents of which is incorporated herein by reference in its entirety.

### FIELD OF THE INVENTION

The present invention relates generally to data communications and, more particularly, to wireless data communications networks.

### RELATED ART

In many telecommunications environments, the primary backhaul network of a telephone network, such as a cellular network, consists of one or more TDM links. For example, typically in the US, one or more T1 or a T3 links are provided from each cell tower or other point of presence, whereas in other regions of the world, one or more E1 or an E3 links are provided.

In certain applications, say in a transport vehicle such as, e.g., but not limited to, an oil tanker or a tugboat, communications devices can offer wireless connectivity, however they can also pose the possibility of providing a distraction to the operator of the vehicle, if the wireless connectivity provides broadband access and access to distracting content. What is needed in these environments, is a communications system which overcomes these shortcomings.

Terrestrial links are also subject to occasional disruption due to physical damage caused by man made or natural disasters. Often such breaks can cause customers to be without telephone and other communications services for many hours, days, weeks and even months. This includes a corresponding break in critical emergency telephone (911) or other designated services.

One solution is to provide a backup connection for all or part of the primary backhaul link that can be used to maintain basic or emergency services during an outage. This should be low cost when inactive and automatically activated in the event of a primary link failure. Although a number of different technologies are available that could provide the basis for backup circuits, such as wireless, fiber, copper, microwave, satellite etc., each has cost or technical limitations.

Of those considered, satellite or wireless Internet Protocol (IP) connections are the most easily deployed at a reasonable cost. Satellites are particularly relevant since they are is not limited by distance or terrain, and there exist providers of low cost IP services via satellite that can provide shared access and be scaled economically for this purpose. However, satellite and wireless IP networks are not typically geared to support a number of transmission protocols and/or systems employed on primary backhaul links, such as TDM based services, and there is no existing product solution that provides automated backup of a number of such backhaul links to such a connection.

IP networks are often used to transport voice communication through voice over IP (VoIP). Often, many simultaneous VoIP calls can cause network disruptions due to a lack of available bandwidth and/or too many packets per second. What is needed is a technology that can combine multiple VoIP packets thereby reducing the number of packets per second and increasing available bandwidth.

### SUMMARY OF THE INVENTION

The present invention sets forth various exemplary embodiments of apparatuses, systems, methods and computer program products for providing automated telecommunications backup.

An exemplary embodiment of the exemplary embodiment sets forth an automated backup system, which includes a first system operable to monitor a primary time division multiplexing (TDM) link on a TDM network for a failure condition, and a second system operable to back up at least a portion of the telecommunications traffic of the TDM link over a backup network.

The backup network may be an Internet protocol (IP) based network, a satellite based network, or an IP based network over a satellite system. The satellite based network or system may include one or more uplinks; one or more downlinks; one or more very small aperture terminals (VSATs); and one or more geosynchronous earth orbit satellites.

The first system may continuously monitor the primary TDM link and switch the functionality thereof into circuit with the TDM link upon the detection of the failure condition. In addition, the first system may stay substantially into circuit with said TDM link and actively terminate both connection endpoints thereof.

In an embodiment, in the event such failure condition is detected by the first system, the second system substantially redirects said telecommunications traffic of the TDM link across the point of link failure. The second system may compress the telecommunications traffic of the TDM link to transmit a pre-designated number of time slots thereof. The second system may use any one of predetermined and preconfigured information to determine which portions of the telecommunications traffic to redirect.

In an embodiment, the second system provides any one of an in-band control channel and an out-of-band control channel to remotely manage any one of the TDM link and the backup network. The control channel may provide two way communications to perform any one of: providing monitoring and control functions; determining real time diagnostic and status information; and determining ancillary information.

In an embodiment, the second system is operable to reestablish the primary TDM link upon detecting by the first system that said primary TDM link has been restored. The reestablishment of the primary TDM link may be performed gradually after predetermined thresholds of stability are met.

In another embodiment where the backup network is an IP based network, the second system further include a locally generated TDM clock to account for any one of delay and jitter requirements of the TDM network over the backup IP network.

In another embodiment, one or more components of the telecommunications traffic of the TDM link are selected for any one of: transmission over the backup network; and blocking thereof.

Another exemplary embodiment sets forth an adaptive telecommunications system for transporting communication traffic over a network, which includes a means for transmitting communication traffic between a plurality of devices through a network, a means for monitoring the communication traffic between the plurality of devices, and a means for adaptively changing the mode of operation of the system before and/or during a call based on at least one of instantaneous network changes, connection type characteristics, and type of communication traffic.

In an embodiment, the devices may include for example, but not limited to, a fax, an analog fax, a digital fax, an analog phone, a digital phone, a mobile phone, or a PBX. The type of communications traffic may include fax, voice, or data. The network may include for example, but not limited to, wireless, terrestrial, or satellite. The connection type characteristics may include for example, but not limited to, cellular, satellite, terrestrial, error prone, or delayed. While the instantaneous network changes may include for example, but not limited to, the traffic load, error rate, number of calls in progress, or time of day.

In an embodiment, the communication traffic may be restricted and/or compressed based on the type of communication traffic content.

In an embodiment, the system may provide overflow capacity and/or a replacement for fixed PSTN circuits.

In an embodiment, the quality of service (QoS) may be maintained based on one of the connection type characteristics, the type of said communication traffic, and instantaneous network changes.

In an embodiment, the mode of operation may be a compression technique applied when a threshold number of calls in progress is met and no longer applied when the number of calls drops below a specified threshold.

In an embodiment, the mode of operation has the capacity to use a different compression algorithm for transmit and receive on the same call. In an exemplary embodiment, the compression occurs in the direction towards a first device (e.g., a PBX), with no compression from the first device (e.g., a PBX) to the plurality of other devices.

In yet another embodiment, when the type of communication traffic comprises multiple VoIP traffic streams the exemplary embodiment may combine the multiple VoIP packet streams into a single packet stream. The exemplary embodiment may also compress the voice samples before combining the multiple VoIP packet streams into a single packet stream. Further, the exemplary embodiment may analyze the VoIP voice streams and suppress any silence.

The foregoing embodiments, together with embodiments directed to methods and computer program products thereof, are described in greater detail below.

### BRIEF DESCRIPTION OF THE FIGURES

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 illustrates an exemplary device in accordance with the present embodiments;

FIG. 2 illustrates an exemplary cellular network connected to the Public Switched Telephone Network (PSTN) in accordance with the present embodiments;

FIG. 3 illustrates an exemplary primary backhaul network and an exemplary satellite based backup network in accordance with the present embodiments;

FIG. 4 illustrates an exemplary embodiment of a computer system that may be used to practice the system and/or methods in accordance with the present embodiments;

FIG. 5A illustrates an exemplary embodiment of the present invention using broadband wireless to replace a typical terrestrial T1;

FIG. 5B illustrates an exemplary embodiment of the present invention using broadband wireless as a backup communications path for an existing terrestrial T1 connection;

FIG. 5C illustrates an exemplary embodiment of the present invention using broadband wireless to replace a typical PSTN connection allowing off premise extensions;

FIG. 5D illustrates an exemplary embodiment of the present invention using broadband wireless to replace a terrestrial T1 connection between a PBX and a carrier switch;

FIG. 5E illustrates an exemplary embodiment of the present invention using broadband wireless to replace connections made through PSTN or AMP networks;

FIG. 5F illustrates an exemplary embodiment of the present invention providing exemplary automatic backup of PSTN links using satellite, IP, or wireless connections, according exemplary embodiments;

FIG. 5G illustrates an exemplary embodiment of the present invention providing exemplary automatic backup of terrestrial links to wireless connections, according exemplary embodiments;

FIG. 6 illustrates an exemplary embodiment of the present invention showing terrestrial primary connections with wireless backup links using, a single exemplary embodiment of the present invention connecting multiple services at the BSC with another exemplary embodiment of the present invention, using the inherent digital TDM cross connect, IP routing, and aggregation functions of both products;

FIG. 7 illustrates an exemplary embodiment of the present invention showing a possible physical embodiment with sample connections and ports such as, power, backup IP (Ethernet) out, backup serial out, local IP data in, control console, T1/E1 in, and T1/E1 out; and

FIG. 8 illustrates an exemplary embodiment of the present invention showing a possible physical embodiment with sample connections and ports such as, power, backup IP (Ethernet) out, backup serial out, local IP data in, control console, T1/E1 in, T1/E1 out, and an optional second module.

### DETAILED DESCRIPTION OF VARIOUS EXEMPLARY EMBODIMENTS OF THE INVENTION

Various exemplary embodiments, including any preferred exemplary embodiments of the invention are discussed in detail below. While specific exemplary embodiments are discussed, it should be understood that this is done for illustration purposes only. A person skilled in the relevant art will recognize that other components and configurations may be used without parting from the spirit and scope of the invention. label

### Intelligent Adaptive System for Transporting PSTN Circuits Over Wireless Networks

According to one exemplary embodiment of the invention, a communications capability may be provided to a mobile user which may provide only limited communications access, such as, e.g., but not limited to, only fax analog connectivity. According to an exemplary embodiment, the connectivity may be provided by transporting a PSTN circuit over a wireless network.

According to one exemplary embodiment, a capability may be provided to change compression technique based on a type of content including, e.g., but not limited to, Fax, data, and/or voice.

### Traffic Type Adaptive Compression

According to one exemplary embodiment, an exemplary system or method can monitor the type of traffic on a particular call and can change the mode of operation of the unit accordingly. For example, according to one exemplary embodiment, an exemplary system or method can automatically recognize a facsimile call and treat it differently than a voice call, or other type of call. Also a data call, according to one exemplary embodiment, can be treated differently from a voice or fax call, or other type of call. In all cases the compression technique can be matched to the type of call being made, according to an exemplary embodiment.

### Connection Type Adaptive Compression Selection

According to one exemplary embodiment, a capability may allow selection of a compression technique based on a connection type such as, e.g., but not limited to, Cellular, Satellite, and/or Error prone, etc.

According to one exemplary embodiment, since one can monitor the type of traffic on a particular call and can change the mode of operation of the unit accordingly, one can also select a compression or “call handling” technique based on the type of call being made, and the quality and/or other characteristic of the connection type. For example, on a voice call, in conditions of high error rate or high packet loss, it may be desirable to use a high compression rate in order to minimize the chance of a lost packet or corrupt packet which would result in “gaps” in the speech of the voice call. Or in another example, on a fax call with long network delays it may be preferable to use a store and forward technique to avoid the possibility of time-outs between fax machines which would otherwise cause the fax call to abort and to prevent the fax from going through.

### Mid-Call Instantaneous Network Change Triggered Adjustable Compression

According to one exemplary embodiment, a capability may be provided to adjust a compression algorithm based on instantaneous network changes such as, e.g., but not limited to, load changes, high error rate, and/or time of day, etc.

According to one exemplary embodiment, an exemplary system and method may also include a capability to change the mode of operation of some types of calls, mid-call. For example, according to one exemplary embodiment, the compression technique may be changed on a voice call, mid-call, at any time, from one compression mode to another. Conventionally, compression or lack of compression was provided only at initiation of a call. Mid-call compression change may be advantageous, if, for example, the error rate of a link would benefit from change due to the impact of various external factors (such as, e.g., but not limited to, weather, and/or sudden changes in network loading, etc.), or if the number of calls in progress increases beyond predefined thresholds, etc. according to an exemplary embodiment. According to one exemplary embodiment, a network link may be provided, which may be capable of supporting, e.g., but not limited to, 4 voice calls without compression, but when adding compression, the same network link may be able to support, e.g., but not limited to, 24 calls (a full T1 capacity), or more, with compression (dependent upon the particular compression algorithm used, and the compression technique's potential ratio of compression). However, the best quality of service (QoS), it should be noted, is typically obtained when no compression is used. The ability to use no compression when, e.g., but not limited to, 4 or less calls are in progress, along with the capability to start compressing existing calls in progress when, e.g., but not limited to, a fifth, or greater call is placed, may allow maximum voice quality to be maintained on the initial calls, for as long as possible. According to one exemplary embodiment, this can also be used as a method to “protect” the quality of certain circuits and to only compress the initial, e.g., but not limited to, 4 calls on an as needed basis, such that compression may be only used on these protected circuits when the voice traffic increases beyond, e.g., but not limited to, one or more predefined threshold levels (e.g., but not limited to, up to 4 thresholds in the example above). According to one exemplary embodiment, as the call volume drops, the compressed calls can also be converted back to uncompressed calls to recover any potential lost quality.

### Compress Asymmetrically to Match Service Rates

According to one exemplary embodiment, a capability may be provided to compress asymmetrically to match, e.g., asymmetric service rates, etc. According to one exemplary embodiment, a system and/or method may be provided allowing one to use a different compression algorithm in each direction, on the same call. Different compression algorithms may use different amounts of bandwidth and may therefore be selected for use on this basis. According to one exemplary embodiment, using different compression algorithms can be advantageous when there is an asymmetric data circuit such as is typical of many wireless data services, where the capacity of the uplink can be less than half the capacity of the downlink, for example.

### Unidirectional Compression of Asymmetric Circuits to Avoid Double Compression.

According to one exemplary embodiment, a capability may be provided to compress in one only direction in asymmetric circuits to avoid double compression

According to one exemplary embodiment, a major advantage of asymmetric compression is that asymmetric compression can avoid the need for “double compression” in a voice circuit. Double compression can occur when there are two separate wireless “legs” or “links” on a voice call, both passing through a central switching system such as a PBX or Carrier Exchange. In a typical compression environment where the voice call is passing from a caller to a PBX and then back out to another caller, where both callers are on wireless links, each voice signal may be compressed and then uncompressed twice on the signal's complete journey from one caller to the other (i.e., compression followed by decompression between a first caller (1) and the central switch/PBX, concatenated with another compression followed by decompression back to a second caller (2)). As described, double compression is generally considered to be undesirable and can lead to significant degradation in voice quality as perceived by the users of the system. The extent of degradation varies greatly, and may depend on the exact combination of compression algorithms and the compression parameters used. Note that cellular voice systems routinely use double compression and are generally considered inferior in quality to land-line telephone systems for this reason. This potential for voice quality degradation due to double compression may be avoided in the system according to an exemplary embodiment of the invention, by virtue of the capability to compress asymmetrically. According to one exemplary embodiment, in the example below, asymmetric compression may allow one to compress in one direction only. As shown in the example below, the voice circuit on both legs (only one leg shown) may be only compressed in the direction towards the PBX, with no compression in the direction outwards from the PBX to any caller. This takes advantage of the fact that there is generally more bandwidth on cellular IP data networks in the direction towards the caller than in the opposite direction (away from the caller).

According to one exemplary embodiment, a single “leg” of and example call which avoids double compression may appear as follows:

Caller X→2205A Unit→Wireless Data Link→IP Network→2205D Unit→PBX or Carrier Exchange.

According to an exemplary embodiment, a link may be compressed towards the PBX only, not on the return.

→Link between 2205's compressed towards PBX only→

### Overflow Capacity for Fixed PSTN Circuits

According to one exemplary embodiment, a capability may be provided featuring providing overflow capacity for fixed PSTN circuits. According to one exemplary embodiment, the capabilities of an exemplary embodiment of the system and method described, may provide for use both as a replacement for terrestrial fixed-line PBX systems, and for use for temporary overflow capability on such systems.

According to one exemplary embodiment, substantial cost savings may be gained by using the present convention to provide a T1 circuit over wireless in replacement of a conventional T1. Exemplary costs of an conventional T1 line contemporary with filing may have various typical costs associated with it, namely, a delivery time of 2-3 months for installation, costs of approximately $400-600 USD per month, and an installation charge of approximately $1,200-2,000 USD. The advantages of using a wireless T1 according to an exemplary embodiment of the invention include dramatic cost savings. Exemplary savings include, e.g., but not limited to, delivery time of upon installation of the equipment, costs of approximately $80-150 USD per month, and installation charges of less than $500 USD.

### Automatic Backup for Fixed PSTN Circuits

According to one exemplary embodiment, a capability may be provided featuring providing automatic backup to fixed PSTN circuits. According to one exemplary embodiment, in conjunction with our automated backup capabilities as set forth in the cross-referenced related patent application, the contents of which is incorporated herein by reference in its entirety, an exemplary version of the system and method may be used to provide unobtrusive monitoring and automated backup of a land-line based telephony system using a cellular data network.

According to one exemplary embodiment of the invention, a model Nx 2205C product series, available from NSGDatacom, Inc., a MD corporation, of Chantilly, Va. may be used and, as an exemplary embodiment, the Nx 2205C may be coupled to or connected to a cellular broadband service, which may, according to an exemplary embodiment, provide cellular broadband via any of various well-known standards including, e.g., but not limited to, EVDO Rev A, or HSDPA, etc.

### Voice Over IP (VoIP) Network Optimization

Throughput limitations of networks carrying a large number of VoIP calls can be a problem for VoIP service providers and carriers. In the standard telephone network (PSTN), 24 simultaneous calls are supported by a single T1 (1.544 Mbps) trunk. Generally, the same trunk can only carry 13 simultaneous VoIP calls without a reduction in quality.

Additionally, every VoIP call typically generates 100 packets per second (pps), and a large number of calls can quickly saturate network elements which have packet throughput limitations. For example, 1000 pps is not an unusual limitation for some equipment. Thus, that equipment can only handle 10 simultaneous voice calls.

According to one exemplary embodiment of the invention, a capacity may be provided to combine the packet streams from multiple VoIP calls into a single packet stream, typically reducing the number of network packets per second (pps) by a factor of 50:1 or more, and reducing bandwidth required for trunking calls over common network connections by up to 3:1. This is achieved according to one exemplary embodiment of the invention by rerouting all VoIP call packets passing between two points to pass through an embodiment of the invention at each end. The embodied invention passes on all call setup information without alteration in order to be transparent to VoIP equipment at each end (e.g., soft switches, IP PBXs, handsets, etc). The embodied invention then traps all IP packets containing voice samples and removes the IP packet header. The transmitting embodied invention then inserts this information into a single IP packet for transmission to the other end of the link. At the other end of the link, the receiving embodied invention then reverses the process and individual expanded voice packets for each call are rebuilt and retransmitted to the end destination. This increases the number of calls supported according to one embodiment of the invention by decreasing the pps.

In another exemplary embodiment of the invention, the packet streams are combined as mentioned above and compression technology is applied. In the embodied invention, before information is inserted into a single packet, all IP packets which contain uncompressed voice samples are trapped and compressed using standard, well known compression algorithms. In this exemplary embodiment of the invention, different combinations of compression algorithms can be used for greater or lesser compression resulting in lower or higher voice quality respectively. Thus, there is an increased number of calls supported when compression is applied according to one embodiment of the invention.

In another exemplary embodiment of the invention, the packet streams are combined and compressed as mentioned above and silence suppression is added. In the embodied invention the use of silence suppression reduces the required bandwidth. Thus, there is an increased number of calls supported when compression and silence suppression is applied according to one embodiment of the invention.

All described exemplary embodiments of the invention are transparent to Session Initiation Protocol (SIP) and Media Gateway Control Protocol (MGCP) VoIP call systems. Further, the exemplary embodiments of the invention reduce both the operational bandwidth required and the packet throughput of the system.

### Exemplary Embodiments

The present embodiments can be performed by one or more products of NSGDatacom, Inc. of Chantilly, Virginia and/or adaptation thereof in accordance with the present embodiments. Such products may include bandwidth optimization router Nx2222™ and network exchange 2205D™, among others.

An exemplary device includes voice and data compression routing capability designed for aggregating and optimizing cellular and PSTN backhaul links. The device may function as a telecommunications switching platform, to reduce network costs for operators by freeing capacity, permitting use of existing services and enabling the introduction of new services.

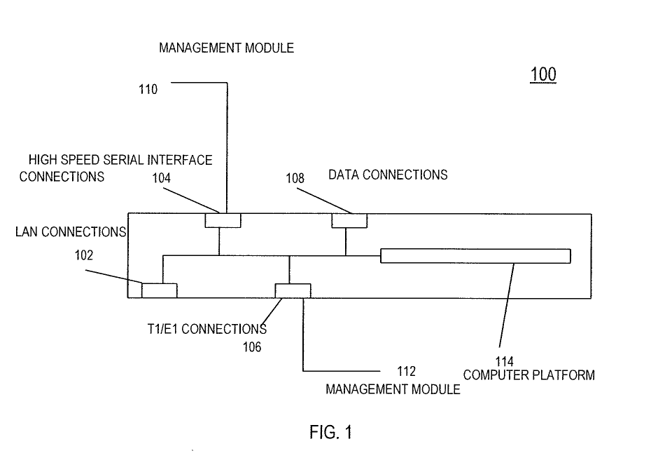

Referring to FIG. 1, device 100 provides hardware, software, or a combination thereof to provide an integrated and/or scalable design. As shown, the exemplary device 100 may include multiple 10/100 Ethernet LAN connections 102, multiple high speed serial interfaces 104, multiple T1/E1 connections 106, and multiple data connections 108.

Exemplary LAN connections 102 may include, for example, multiple integrated switched Ethernet interfaces, auto sensing enabled 10BaseT or 100BaseT user or hub connectivity.

Exemplary high speed serial interfaces 104 may include, for example, RJ 45 interfaces, internal or external clocking, software configurable DTE/DCE, V.24/RS-232/V.35/RS-449/X.21, and/or high speeds from, for example, 1200 bps to 2.048 Mbps.

Exemplary T1/E1 connections 106 may provide digital voice and/or data, up to multiple channels of voice compression, drop and insert for DS0/timeslots between interfaces, support for CAS and ISDN, transparent pass through for signaling via SS7, and/or transparent TDM clock recovery over IP. Examples of connectivity provided includes, for example, from 2 to 18 T1/E1 circuits of GSM Abis or Ater traffic (as defined below), up to, for example, 548 PSTN voice, facsimile or fractional data channels accommodated therein.

Exemplary data connections 108 include voice and/or facsimile connections, exemplary IP connections, and/or exemplary Frame Relay connections, to name a few. Exemplary voice and/or facsimile connections may include, for example, support for CAS/ISDN/E&M, H.323, SIP, B2BUA, G.711, G.729a, CELP 4.8/7.4 kbps, ACELP 5.5/8.0 kbps, V.27 ter, V.29 and/or Group III. Exemplary IP connections include, for example, support for VoIP, RIPv1/2, OSPF, Static Routing, SNMP, SFTM, H.323, SIP and/or B2BUA. Exemplary Frame Relay connections may include, for example, Frame Relay NNI, UNI, FRF4/ITU, Q.933, Frame Relay Annex D, LMI, including PVC and/or SVC support.

A management module 110 may interface with device 100, for example, through high speed serial interface connections 104. Management module 110 may include, for example, a Graphical User Interface (GUI) hosted, for example, by a Microsoft Windows® PC. Configuring, monitoring and troubleshooting over public, private or hybrid networks may be provided. Distributed management of existing equipment via Simple Network Management Protocol (SNMP) may also be provided. Management may also be provided remotely. For example, a management module 112 may provide remote management support over T1/E1 connections 106. In an exemplary embodiment, device 100 is remotely configurable using a GUI management system.

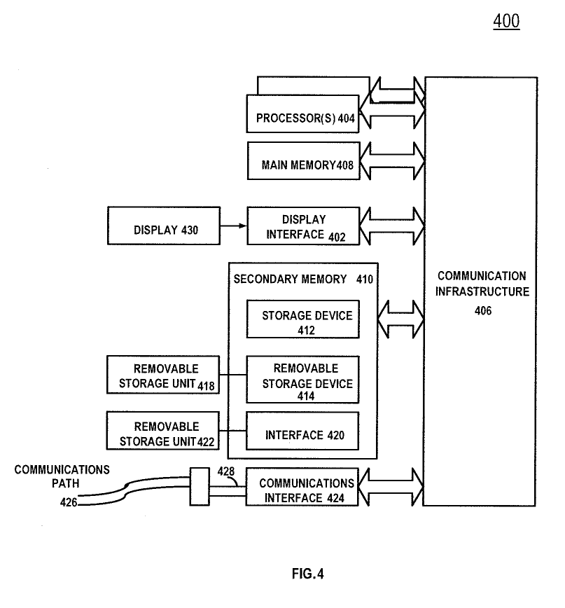

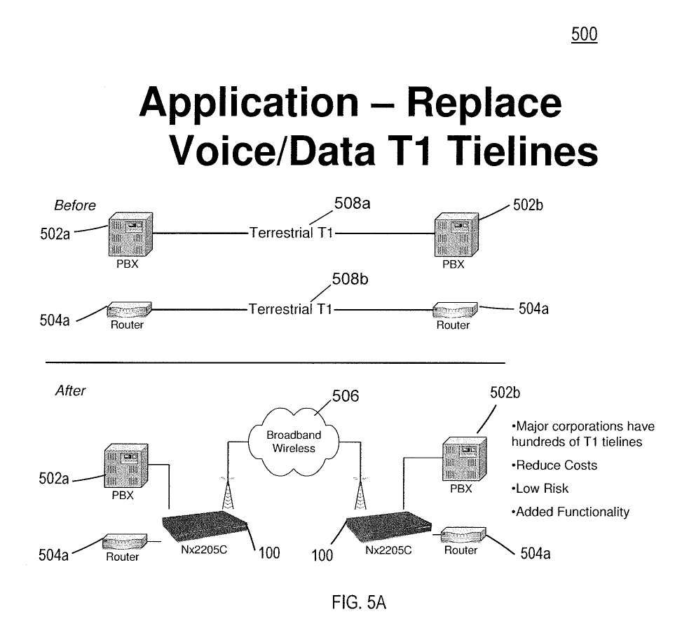

In one or more embodiments device 100 includes an internal or remotely accessible computer platform 114 that can perform any and all functions associated with internal processing and the foregoing network connections and associated protocols. The computer platform 114 can receive and execute software applications and display data transmitted from a management module or another computer device. The computer platform 114 may include an application-specific integrated circuit (“ASIC”), or other chipset, processor, microprocessor, logic circuit, or other data processing device. The ASIC or other processor may execute an application programming interface (“API”) that interfaces with any resident programs, in a memory of the device 100. The API may be a runtime environment executing on the device 100, to operate to control the execution of applications on the device. The memory may include read-only and/or random-access memory (RAM and ROM), EPROM, EEPROM, flash cards, or any memory common to the computer platform 114. The computer platform 114 may also include a local database that can hold the software applications, or data not actively used in memory. The local database may include flash memory cells, or secondary storage, such as optical or magnetic media, tape, or soft or hard disk. In addition, computer platform 114 may be replaced by and/or may function in addition to any or all of the components of computer system 400 shown in FIG. 4.

In an exemplary embodiment, computer platform 114 provides device 100 PSTN voice compression capability via compression algorithms. Device 100 may support a mixture of both analog and/or digital PSTN voice connections with compression to a maximum of a predefined number of analog voice ports and/or digital (T1/E1) trunks per unit, with an overall maximum of voice, facsimile and/or data (DS0) circuits per unit. Analog voice ports can be configured for connection to a local PBX or to telephone handsets. The compression algorithms of computer platform 114 may, for example, provide bandwidth savings with toll quality voice compression using silence suppression (with optional user comfort noise). The compression algorithms may be used for military applications due to high quality, low bandwidth utilization and fixed rate algorithms optimized for low bandwidth satellite networks. The algorithms provide for queue buffer, jitter buffer and/or echo cancellation mechanisms deployed to maintain quality over circuits with long delays such as multiple satellite hops.

In an exemplary embodiment, computer platform 114 provides device 100 PSTN IP Gateway with Packet Switching capability via gateway and switching algorithms. As interoperability is provided, device 100 may conform to H.323 v2 and SIP (including B2BUA), enabling integration with soft switches and PC-based telephony. Device 100 provides comprehensive gateway functions that allow interfacing between different network services and types. For example, device 100 may compress SIP traffic over satellite connections, simultaneously reducing the bandwidth used by a factor and reducing the number of IP packets transmitted by a factor.

In an exemplary embodiment, computer platform 114 provides device 100 cellular backhaul and/or disaster recovery capability via cellular backhaul and/or disaster recover algorithms through, for example, integrated digital cross connect and compression gateway capability. These embodiments, described in greater detail below, are made capable via the backhaul and/or disaster recovery algorithms. In one or more such embodiments, backhaul and/or disaster recovery are provided by backup satellite links.

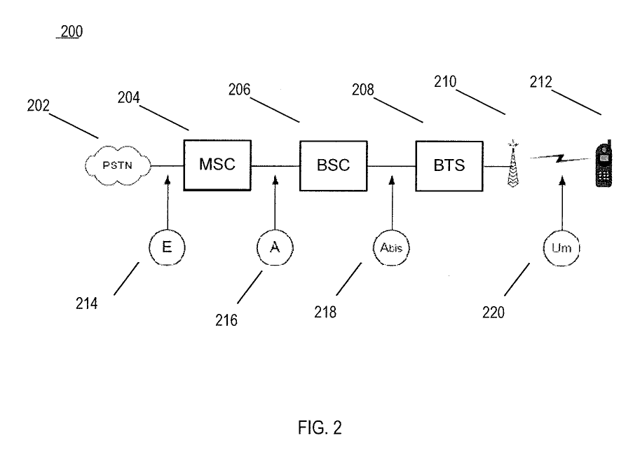

FIG. 2 illustrates an exemplary cellular network 200 connected to the PSTN. As shown, PSTN 202 is linked to mobile device 212 via MSC (mobile switching center) 204, BSC (base station controller) 206, BTS (base station transceiver) 208 and antenna 210. In the illustrated exemplary embodiment, cellular network 200 is a GSM system, though the present embodiments may be employed with any type of network, cellular or non-cellular.

MSC 204 controls the call set up for incoming and outgoing calls, and interfaces to PSTN 214 and other mobile networks. Typically in GSM, all calls go through MSC 204. BSC 206 allocates radio channels to individual calls and performs hand-offs between BTSs 208 located within the same BSC 206. BSC 206 also normally performs the GSM specific voice compression. A single BSC 206 may support many BTSs for coverage of a larger geographic area. BTS 208 performs the transmission over the air to the mobile device 212. BTSs 208 are located at the cellular towers throughout the coverage area. BTS 208 may include one or more GSM radios, each of which typically supports eight GSM voice calls.

The links between the foregoing units may comprise E1 links in a GSM embodiment. Accordingly, the interfaces between systems may be GSM interfaces. As shown, the respective interfaces may comprise an E interface 214 between PSTN 202 and MSC 204, an A interface 216 between MSC 204 and BSC 206, an Abis interface 218 between BSC 206 and BTS 208, and an Um interface 220 between antenna 210 and mobile device 212.

Abis interface 218 is used to connect BSC 206 and BTS 208. As there are more BTSs 208 in the network than other components, the Abis interface is typically the most common interface for the GSM network. An Ater interface (not shown) may also be implemented between a TRAU (transcoder rate adapter unit) and BTS 208. Though the TRAU, which performs voice compression, is normally located in BSC 206, it may be relocated to the MSC 204, wherein the Ater interface is implemented.

In exemplary embodiments, satellite communications are provided by Very Small Aperture Terminal (VSAT), two-way satellite ground stations with a dish antenna typically smaller than 3 meters. VSATs typically access satellites in geosynchronous orbit to relay data from small remote earth stations called terminals to other terminals in typically mesh configurations or master earth station hubs in star configurations. VSAT data rates range from about narrowband up to approximately 4 Mbit/s. As used herein, the VSAT may used to transmit narrowband data, such as polling or RFID data or SCADA, or broadband data, for IP access to remote locations, VoIP or video.

In the present embodiments, a VSAT may employ a plurality of transmission protocols. In one exemplary embodiment, the DAMA protocol transmission is used to share bandwidth in a time division mode. DAMA transmission may be used in a packet-switched environment for transmission of a large amount of data. DAMA transmission may also be used for a circuit-switched connection, wherein each user is permitted a variable slot of time on a demand (or request) basis.

In another embodiment, SCPC/MCPC protocol transmission is used. In exemplary embodiments, SCPC/MCPC provides dedicated satellite link between a few distinct locations, where the links support either a single telephone line or several telephone or data lines. The links may, for example, be permanently assigned with no carrier switching or rerouting over the satellite.

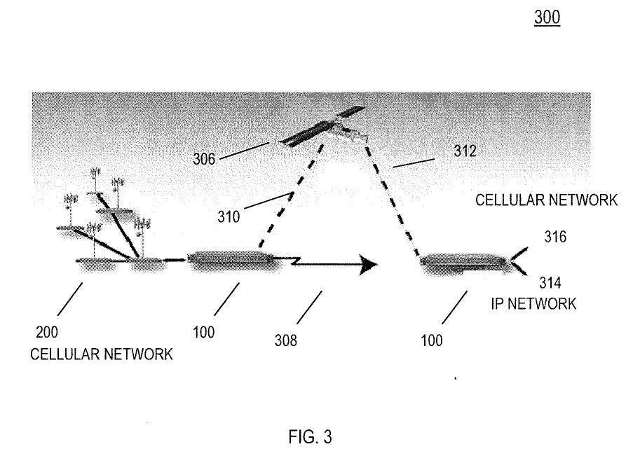

FIG. 3 illustrates an exemplary backhaul and/or disaster recovery environment 300 in accordance with the present embodiments. Environment 300 includes the foregoing cellular network 200, another cellular network 316, and an IP network 314. Environment 300 also illustrates a device 100 (left side) connected to cellular network 200, and another device 100 (right side) connected to cellular network 316 and IP network 314.

In an exemplary embodiment, a link 308 exists between first device 100 (left side) and second device 100 (right side), which link may be across any number of telecommunications equipment. The links between the devices 100, or between any of the telecommunications devices shown or which may be used, can employ any known protocol over any known telecommunications connection. In an exemplary embodiment, any of links 308, 310, 312, for example, provide IP based backup connections, and link 308 may, for example, provide a TDM based primary backhaul connection over any trunk types, such as T1 or E1, across any combination of telecommunications equipment.

In exemplary embodiments, core or backhaul traffic may be transmitted across the circuits of exemplary network 200, across link 308, to network 316 and/or network 314. Here, in the event of a failure across link 308 for disaster or any other reason, the satellite system comprising links 310, 312 and satellite 306 are employed for traffic backup and/or rerouting. However, traffic backup and/or rerouting may be implemented in accordance with the present embodiments using any other telecommunications system, and not just a satellite system as shown, including landline and/or wireless systems.

As understood by skilled persons, cellular networks 200 and 316 may also respectively represent portions of the same cellular network. The devices may also be connected via respective VSAT terminals (not shown) or other satellite communications enabling devices with exemplary satellite 306. In exemplary embodiments, the respective uplink 310 and downlink 312 are connected over DAMA, SCPC, MCPC or other enabling protocols for transmission.

In differing embodiments where first device 100 (left side) and second device 100 (right side) provide communications between cellular network 200 and cellular network 316, for example, the satellite communications may be provided across one of the foregoing GSM or alternative interfaces. For example, in one embodiment where first device 100 (left side) is connected to BSC 206 of cellular GSM network 200, and second device 100 (right side) is connected to BTS 208 of cellular GSM network 316, the satellite communications is provided across an Abis interface. Similarly, in another exemplary embodiment, the satellite communications is provided across an Ater interface between the devices 100.

In exemplary embodiments, where cellular backhaul and/or disaster recovery algorithms are employed, first device 100 and second device 100 comprise components of the core or backhaul of the network comprising networks 200, 316 and/or 314. As part of its functions, devices 100 may be integrated cross connect and/or compression gateways for Abis and Ater backhaul applications. For example, a number of full or fractional T1 or E1 voice/data circuits can be connected directly to the devices 100 and individual DS0s may be compressed and merged for transmission over TDM, Frame Relay or IP packet-based connections. The unused voice channels can be dynamically compressed, for example, to save bandwidth on terrestrial connections 308 or satellite connections 310, 312. TDM clock recovery may permit TDM circuits to be merged and/or transparently transmitted over IP satellite, wireless, or terrestrial links. This may include standards compliant clock regeneration and jitter buffering to synchronize remote locations to the central network. Device 100 may also communicate with a backhaul optimization and/or access router as well, and any connection into the device 100 may be configured as a network trunk or access port.

In exemplary embodiments, where cellular backhaul and/or disaster recovery algorithms are employed, first device 100 and second device 100 provide disaster recovery services. In these embodiments, device 100 provides an efficient, management oriented solution for backing up network circuits (for example, TDM network circuits), suited to situations where complete or partial failure of a circuit might cause disruption or loss of emergency services. Disaster recovery algorithms permit monitoring of the links, such as exemplary TDM links 308, and if failure is detected, automatically take control over the circuit, such as the exemplary TDM circuit, and route pre-determined traffic onto a designated backup link, such as via exemplary uplink 310 to satellite 306, and exemplary downlink 312. In exemplary embodiments, in the foregoing pass-through mode there is no delay through the devices 100 and complete power failure to the devices of the exemplary T1/E1 circuit 308 being monitored.

In exemplary embodiments, devices 100 permit remote configuration and control of the disaster recovery functions. A range of parameters of the circuit, such as the exemplary TDM circuit, are monitored with thresholds set to trigger, for example, an alarm for manual intervention, or automatic fail-over to one or more backup connections. In these embodiments, once the primary link 308 is restored traffic may be manually routed back onto the primary connection or automatically switched based on pre-set parameters. Operation of the backup operation can be implemented and/or optimized for operation over any types of links, including satellite networks and connections 310, 312, 306, wireless networks such as cellular networks 200, 316, as well as T1/E1 voice/data links over low speed terrestrial networks. The disaster recovery algorithm permits VPN or other security as well for protecting sensitive communications. Disaster recovery embodiments are provided in greater detail below.

### First Disaster Recovery Embodiments

In a first set of embodiments, devices 100 provide the ability to unobtrusively monitor a link, such as for example a TDM link, and detect when it fails. While exemplary attributes such as TDM types of links, or T1 and E1 types of trunks are described herein, the foregoing terminology are employed for illustrative purposes only and in no way to be construed as limitations of the present embodiments.

In these embodiments, device 100 can unobtrusively monitor the transmit and receive data lines of an existing link, such as a TDM data link (for example, T1, E1, T3, E3) 308 via monitoring equipment and the disaster recovery algorithms can analyze the monitored activity and determine from this the status and thus functionality of the monitored link 308. Device 100 can continuously analyze the activity on the link and compare the status of the link with one or more predetermined (programmable) thresholds.

Both the local TDM equipment and TDM transmission equipment may be connected to the described backup device 100 such that under normal operation a direct connection (like a normal through “patch panel”) can be provided between the two. Here, in the event of a failure of the TDM link, the failure may be detected by the device 100, which only then would switch itself into circuit.

In an alternative embodiment, the configuration comprises for the monitoring device 100 to always be in circuit and actively terminate both sides of the TDM link. In the event that the TDM circuit fails, the equipment may route the existing traffic from the local side of the link 308 across the backup path 310. In exemplary embodiments, this approach adds a delay during the normal operation of the link and potentially added unreliability (decreased MTBF) resulting from the insertion of the new equipment into the otherwise active TDM circuit. MTBF generally refers to Mean Time Between Failures, and is a standard term used in the industry and can be calculated very precisely.

The monitoring may be performed by a combination of hardware and/or software. Non-disruptive monitoring circuitry may, for example, decode the T1/E1 signal which is then analyzed by software to determine if the link is active. All of this may be embodied within device 100.

### Second Disaster Recovery Embodiments

In a second set of embodiments, devices 100 provide the ability to ‘take over’ the TDM connection to the cellular equipment at the local end and to redirect the backhaul traffic congested at connection 308 through device 100 and onto the backup connection, such as over uplink 310 to satellite 306, and onto downlink 312 to another device 100, or to other network components.

In the event that the operational status of the TDM link is determined by the monitoring equipment and disaster recovery algorithm to be outside normal operational conditions, as may be indicated by one or more of the monitored parameters crossing a predetermined threshold, device 100 may disconnect the local equipment from the TDM link 308 and establish a direct connection to the equipment such that the equipment may continue to operate as if it were still properly connected to the network.

A wide range of parameters may be monitored. For example, a simple line monitor for bidirectional activity may be used to establish that the link is physically present, connected and active. The quality of the link can be determined by monitoring alarm conditions and error rates on the link. The stability of the link can be monitored for intermittent interruptions which may cause the link to be unusable for periods. Such interruptions might be due a variety of external events that are, for example, man made or otherwise, such as periodic line testing, weather related incidents, intermittent hardware problems, satellite or wireless connectivity outages, physical damage to lines, etc. Poor link stability may, for example, result in “bouncing” between the backup link and the primary link, unless link stability is monitored over an extended period appropriate to the connection environment. In this embodiment, device 100 may be fully capable of terminating and interoperating with a fully functional link, such as a TDM link, of which there are numerous varieties and of which T1 and E1 are specific examples.

### Third Disaster Recovery Embodiments

In a third set of embodiments, devices 100 provide the ability to compress the primary link, such as the primary TDM link, and only transmit required (pre-designated) portions, such as timeslots, over the backup connection. In one or more embodiments assumed here, backup bandwidth over satellite links 310, 312 may be normally be lower than that of the TDM link 308, although the latter may not be correct where the satellite circuit has the capability to provide additional bandwidth on demand.

Having determined that the backhaul circuit, for example TDM backhaul circuit, has failed and thereafter established a connection to the local equipment, devices 100 may use predetermined and/or preconfigured information to determine which parts of the circuit 308 need to be transmitted over the backup path.

Depending on the backup path being used a number of different options may be implemented at this time. For example, if the backup path is satellite circuit 310, 312, which may be part of an on-demand system such as a DAMA satellite system, device 100 may request the desired bandwidth from the system by a means standard in the industry. In this exemplary embodiment, the device 100 would select the designated portions of the circuit that need to be transmitted, possibly by function or position in the stream (for example, selected DS0's or designated emergency telephone calls), compress these if desired, convert to the appropriate protocols desired and/or required, and transmit these over the back-up path. In the event that there are multiple services being backed up, the ability to prioritize these services can be provided by devices 100, such that emergency services are given first priority, but other telephone or data services may make use of the services when not being used to provide emergency communications.

In an exemplary embodiment where the backup path is a wireless link, the process is similar to the above but may or may not include one or more of the latter functions, such as compression. This is because the bandwidth available on wireless links is typically far greater than that available on the illustrated satellite links. Also the expected delay over a satellite link is typically far longer than would normally be tolerated over a wireless link. Delays can be minimized over the wireless link by eliminating unnecessary computationally intensive functions such as voice and data compression.

### Fourth Disaster Recovery Embodiments

In a fourth set of embodiments, devices 100 provide a control path to the tower equipment for equipment management purposes. In certain embodiments, the backup connection may used to provide an “in band” control channel for remote access to devices 100 in times of emergency. During standard operation, management access to the equipment may normally be provided over the exemplary TDM link or over ancillary connections such as a dial-up line, private IP, or a public Internet connection. The control channel may provide, for example, two-way communication to devices 100 for the purposes of monitoring and control, to provide real time diagnostic and status information, and to provide ancillary information such as call detail records used for load analysis and billing purposes.

In certain embodiments, the control channel may be used to inform the management system (which may be located anywhere in the world) for example, that there has been a failure, and that the backup circuit is up and running. Although the initial configuration of the unit may be to bring the backup circuit on line in minimal configuration, once the control channel has allowed direct operator control of the equipment, additional capacity may be added or other operational parameters may be programmed into the system in real time as required. In the event that the primary link, for example connection 308, is reestablished, the equipment may be programmed to fall back to the primary link gradually, or after certain other thresholds of stability have been met. Alternatively, the control channel may be used such that the switch back to the primary link is made entirely under manual control, with real time status information viewed by the remote operator being used to make the decision.

### Fifth Disaster Recovery Embodiments

In a fifth set of embodiments, devices 100 provide the ability to convert between transmission protocols, such as from a TDM data structure to IP, and back again. The latter may include, for example, clock regeneration and jitter buffering at the remote location to maintain synchronization to the core network.

An exemplary feature of the equipment described is the ability to provide a backup path for the TDM links as transparently as possible to the systems connected at both ends, regardless of the transport medium and the protocol used to provide the backup connection. Two variables that may be accommodated in order for the proposed solution to be flexible and operate with a wide variety of potential network solutions include (i) accommodation for a wide potential variation in time delay across the network path, and (ii) buffering to allow the continuous operation of the first transmission protocol, such as exemplary TDM circuits, while receiving and transmitting discontinuous data packets over the second transmission protocol, such as exemplary IP connection (for example, to compensate for gaps between blocks of information received from the IP network that need to be continuously transmitted without a break over the TDM circuit).

In an exemplary TDM circuit the data may be continuously transmitted without a break and each bit may be timed with a precise clock that is distributed from the core network outwards. For example, it is normally essential to the operation of a typical TDM network that the clock signal be passed transparently downstream from network node to network node without a break. On the other hand, in an IP network typical of the exemplary satellite and wireless backup networks described above, data may be divided into discrete packets of information which are independently transmitted over the network with varying gap times between the packets. Due to this basic difference in mode of operation there is no inherent way to directly pass TDM clock timing between IP network nodes.

As outlined above, the basic method of operation of an IP packet based network is that of accumulating information for a period of time and then transmitting it in a burst of data known as a packet. There is therefore a period of accumulation during which time the data is stored at the transmitting end of the link, a processing delay while the “packet” is created, a period of packet transmission, a period of accumulation at the receiving end of the link, a period of processing at the receiving end of the link and finally a period of transmission to the local equipment. The actual delays incurred may vary considerably from packet to packet with the result that some or all TDM timing is lost during the conversion from TDM data into an IP packet and back again. In addition to the variations in packet delay incurred during the process described above, additional very significant delays may be incurred traversing the network architecture, specifically in the case of satellite links such as links 310, 312, but also over international links such as through gateways between public IP networks (not shown). Timing at the received (remote) end of the link may be synchronized to the primary network using a combination of high speed electronic hardware and controlling software. The mechanism used to recover and maintain timing synchronization between the remote and head ends of the link can be adjusted, for example, through a range of operating parameters to optimize changes in clock frequency variance according to the general requirements and jitter specifications of the core network.

In accordance with the present embodiments, disaster recovery algorithms of computer platform 114, of an exemplary device 100, provide the capability of taking exemplary TDM data received in discontinuous packets from a remote transmitting station and recreating a continuous, timed, TDM circuit at the receiving end of the link. A wide variation in packet and network delays can accommodated by the equipment such that from the viewpoint of the end equipment, completely transparent end-to-end TDM operation is accomplished. Device 100 provides seamless conversion to IP and back again through the foregoing so that conventional IP network links such as satellite, wireless and terrestrial IP networks can be used to provide an automated backup function to TDM circuits.

For example, in an embodiment the clock at the remote location (receiving end) of the link may be set to the nominal working frequency of the core network. Received data may be stored in a temporary buffer, the size of which is adjusted to allow for any mismatch between the clocks at each end of the link. Each clock cycle at the remote location may correspond to the transfer of one bit of data out of the buffer. At the remote location, the local clock may need to be adjusted slightly (for example, by a minuscule amount) up or down to match the core network clock rate. If the remote clock is slower than the core rate, for example, the temporary storage buffer may eventually be overrun (overfill), causing a network error. If the remote clock is faster than the core rate, the temporary storage buffer may eventually under-run (run-out), also causing a network error.

In addition, the data received from the core of the network may not be received at a steady rate but received in packets, the contents of which are stored in the local buffer en-mass before being transmitted to the local T1/E1 equipment. Additionally, there may be a variation in the delay between packets received over the link. Data may be clocked out from the buffer at a constant bit rate, based on the local clock.

Here, the clock regeneration algorithm may have to determine which direction the clock at the receiving end would need to be adjusted even though the buffer may be refilled at different times and in a different way than it is being emptied. The adjustment may be based, for example, on average readings of how full the buffer is over a long period of time, to smooth out the effect of network delays and the low delivery rate of packets. In varying embodiments, the decision by how much and how often to adjust the clock up or down may be limited by the clock jitter specifications of the local equipment and/or network. This may be accomplished, for example, by careful selection of buffer size, packet size and choice of averaging algorithm. These parameters may be adjusted in the context of wider configuration criteria, such as the number of different locations being supported, the number of trunks being supported to each location, and overall packet throughput limitations of the attached equipment and network.

In an exemplary embodiment, device 100 uses the following method to accomplish this conversion using a locally generated TDM clock. For example, the locally generated TDM clock is based on a standard crystal generated timing circuit that is a close approximation to the desired TDM clock rate. The circuit may be designed such that it can be minutely changed under the control of computer platform 114 to be slightly faster or slower than the nominal rate. By buffering data at the receiving end of the link, the locally generated TDM clock may be adjusted to keep the incoming IP data buffer at a desired mean (average) capacity level by nudging the TDM clock to be slightly faster or slightly slower at regular intervals. In an embodiment, the size of the buffer, the frequency and size of the adjustments, and the total amount the nominal frequency of the clock are adjusted under such control to meet the delay and jitter requirements of the network and/or equipment attached. Using this method TDM timing can be generated at the remote end that keeps the buffer from either underflow or overflow, and therefore can keep the remote equipment in delayed operational synchronization with the primary network.

Referring back to the third embodiment, in an exemplary illustration of the third embodiment, the embodiment may primarily cover the backup of preselected channels (for example, channels 1-12 out of, for example, 22 channels) from all active channels. In this illustration, only such preselected channels may be backed-up. Here, the number of selected channels may be matched to the bandwidth available on the backup service, which may be obtained from a shared pool of available bandwidth (for example, from a shared satellite link), with other dynamic services such as called-number blocking being added on top.

In the present embodiment, some flexibility may be added to such an illustration of the third embodiment. For example, specifying which channels are being backed up may be avoided, and only those calls which have met certain criteria may be passed through the system. Following the above example, even though space for only 12 channels may be available on a backup link, all 22 circuits may, for example, be backed up with only the first 12 that meet the selection criteria being be passed through. The selection of which 12 out of 22 are passed through may be automatically and dynamically chosen, based on the called criteria at the moment.

This section also deals in a little more depth with dynamic functions such as call blocking based on other criteria than just the number called, such as time of day or what backup circuits are in service.

### Sixth Disaster Recovery Embodiments

In a sixth set of embodiments, devices 100 provide the ability to present a full link structure (for example a TDM link structure) to the cellular carriers (for example for cellular networks 200, 316) at both ends of the exemplary link 308, while only transmitting information from certain designated timeslots across the backup IP connection. The latter may allow a much lower bandwidth connection over, for example, exemplary satellite link 310-312 (for example, 300 Kbps) to backup a full T1/E1/T3 or multiple T1/E1/T3 connections. Using this example, a 300 Kbps backup IP connection using exemplary device 100 permits a range, for example from 16 to 24 (depending on configuration) of emergency backup circuits to an exemplary cell tower.

In certain embodiments where the TDM data stream at both ends of the exemplary link 308 are broken down and rebuilt along with some or all applicable timing at the receiving end of the link, namely at second device 100 (right side), the data may undergo significant processing before being actually transmitted over the backup link, such as exemplary backup system 310-312. This is most significant when relatively expensive satellite network connections are used for backup, in which case in the present embodiments the voice and data circuits may be compressed before transmission in order to minimize the bandwidth used, and hence minimize backup link cost.

Furthermore, the payload of some timeslots may be selected for being dropped entirely under predefined or real time determined circumstances, in order to minimize the satellite bandwidth used. This is possible because the structure of the TDM data stream at the remote location is entirely under the control of the equipment there, and can be rebuilt as if those specific data timeslots were not being used at all. This capability allows selective call blocking to be performed during an emergency (for example at an isolated cell tower) and may be used to block certain call types, or alternatively only allow calls to certain numbers from traversing the network when the backup link is active, or when other criteria are met (for example, time of day/week/year etc.).

### An Exemplary Computer System

FIG. 4 depicts an exemplary embodiment of a computer system 400 that may be used in association with, in connection with, and/or in place of, but not limited to, computer platform 114, according to exemplary embodiments of the present invention.

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 400 is shown in FIG. 4, depicting an exemplary embodiment of a block diagram of an exemplary computer system useful for implementing the present invention. Specifically, FIG. 4 illustrates an example computer 400, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 400 is shown in FIG. 4. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 4.

The computer system 400 may include one or more processors, such as, e.g., but not limited to, processor(s) 404. The processor(s) 404 may be connected to a communication infrastructure 406 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 400 may include a display interface 402 that may forward, e.g., but not limited to, graphics, text, and other data, etc., from the communication infrastructure 406 (or from a frame buffer, etc., not shown) for display on the display unit 430.

The computer system 400 may also include, e.g., but may not be limited to, a main memory 408, random access memory (RAM), and a secondary memory 410, etc. The secondary memory 410 may include, for example, (but not limited to) a hard disk drive 412 and/or a removable storage drive 414, representing a floppy diskette drive, a magnetic tape drive, an optical disk drive, a compact disk drive CD-ROM, etc. The removable storage drive 414 may, e.g., but not limited to, read from and/or write to a removable storage unit 418 in a well known manner. Removable storage unit 418, also called a program storage device or a computer program product, may represent, e.g., but not limited to, a floppy disk, magnetic tape, optical disk, compact disk, etc. which may be read from and written to by removable storage drive 414. As will be appreciated, the removable storage unit 418 may include a computer usable storage medium having stored therein computer software and/or data.

In alternative exemplary embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 422 and interfaces 420, which may allow software and data to be transferred from the removable storage unit 422 to computer system 400.

Computer 400 may also include an input device such as, e.g., (but not limited to) a mouse or other pointing device such as a digitizer, and a keyboard or other data entry device (none of which are labeled).

Computer 400 may also include output devices, such as, e.g., (but not limited to) display 430, and display interface 402. Computer 400 may include input/output (I/O) devices such as, e.g., (but not limited to) communications interface 424, cable 428 and communications path 426, etc. These devices may include, e.g., but not limited to, a network interface card, and modems (neither are labeled). Communications interface 424 may allow software and data to be transferred between computer system 400 and external devices. Examples of communications interface 424 may include, e.g., but may not be limited to, a modem, a network interface (such as, e.g., an Ethernet card), a communications port, a Personal Computer Memory Card International Association (PCMCIA) slot and card, etc. Software and data transferred via communications interface 424 may be in the form of signals 428 which may be electronic, electromagnetic, optical or other signals capable of being received by communications interface 424. These signals 428 may be provided to communications interface 424 via, e.g., but not limited to, a communications path 426 (e.g., but not limited to, a channel). This channel 426 may carry signals 428, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 414, a hard disk installed in hard disk drive 412, and signals 428, etc. These computer program products may provide software to computer system 400. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 408 and/or the secondary memory 410 and/or removable storage units 414, also called computer program products. Such computer programs, when executed, may enable the computer system 400 to perform the features of the present invention as discussed herein. In particular, the computer programs, when executed, may enable the processor 404 to provide a method to resolve conflicts during data synchronization according to an exemplary embodiment of the present invention. Accordingly, such computer programs may represent controllers of the computer system 400.

In another exemplary embodiment, the invention may be directed to a computer program product comprising a computer readable medium having control logic (computer software) stored therein. The control logic, when executed by the processor 404, may cause the processor 404 to perform the functions of the invention as described herein. In another exemplary embodiment where the invention may be implemented using software, the software may be stored in a computer program product and loaded into computer system 400 using, e.g., but not limited to, removable storage drive 414, hard drive 412 or communications interface 424, etc. The control logic (software), when executed by the processor 404, may cause the processor 404 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE 802.11g-2003, etc.), etc.

### Overview of Various Exemplary Embodiments

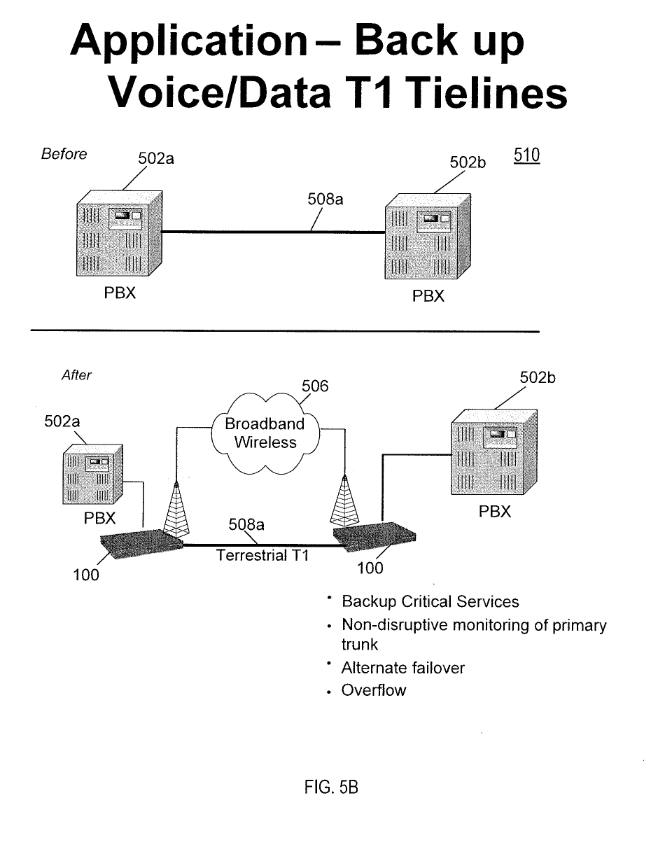

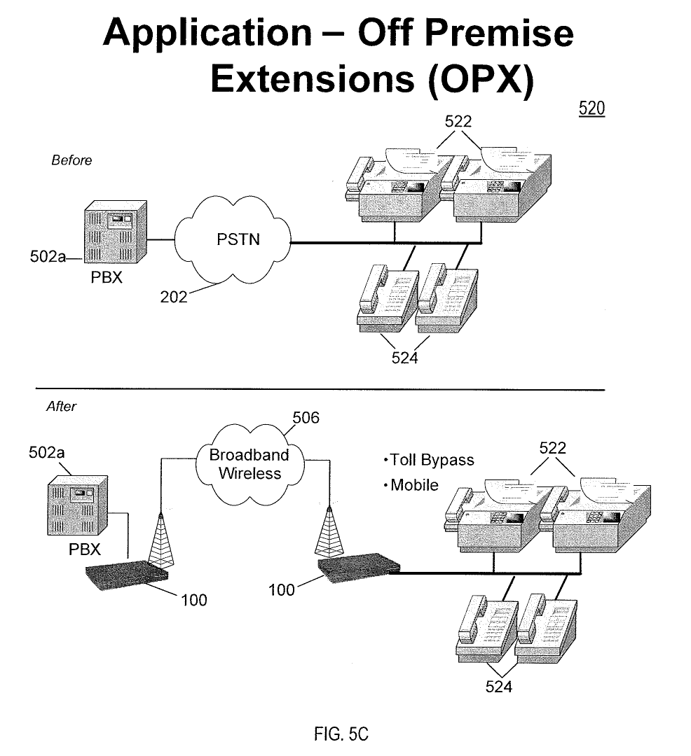

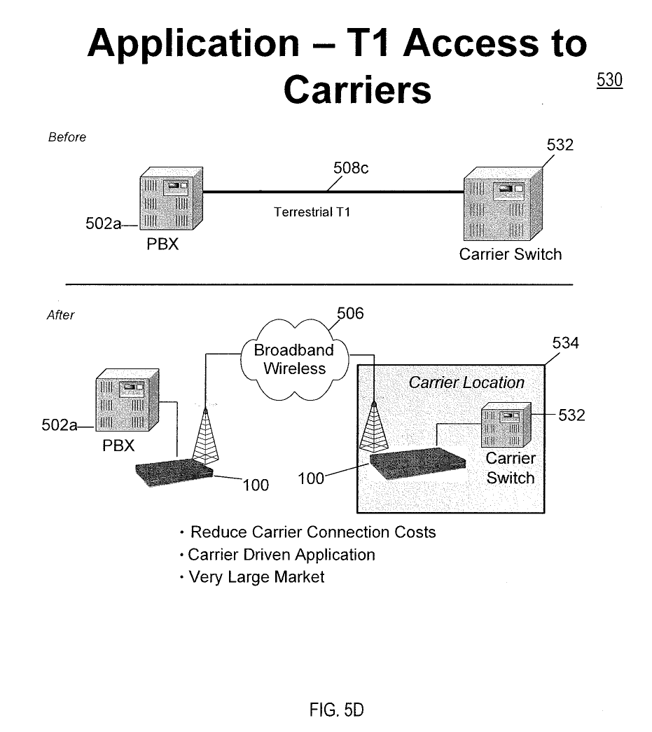

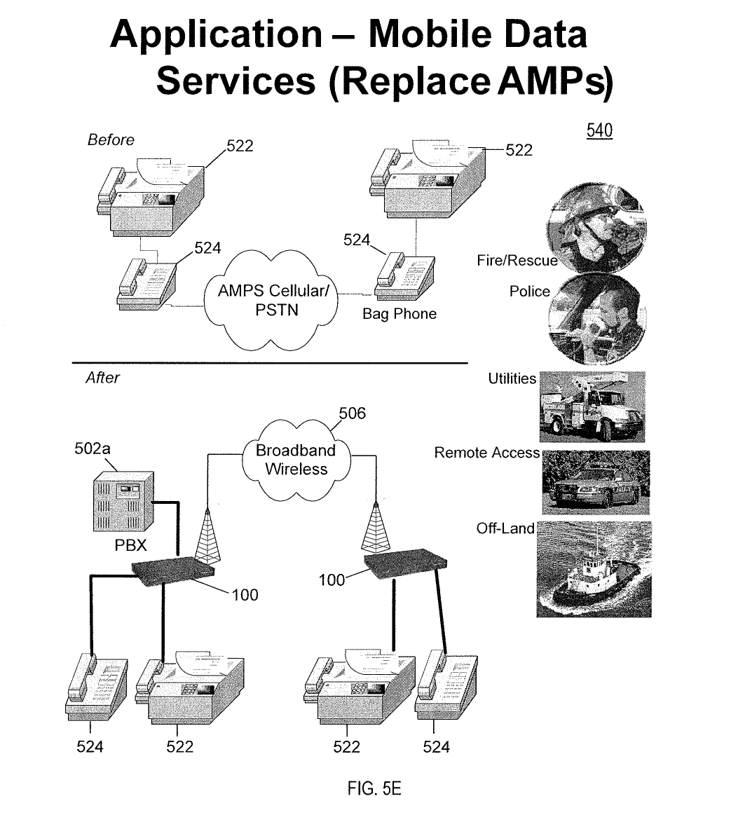

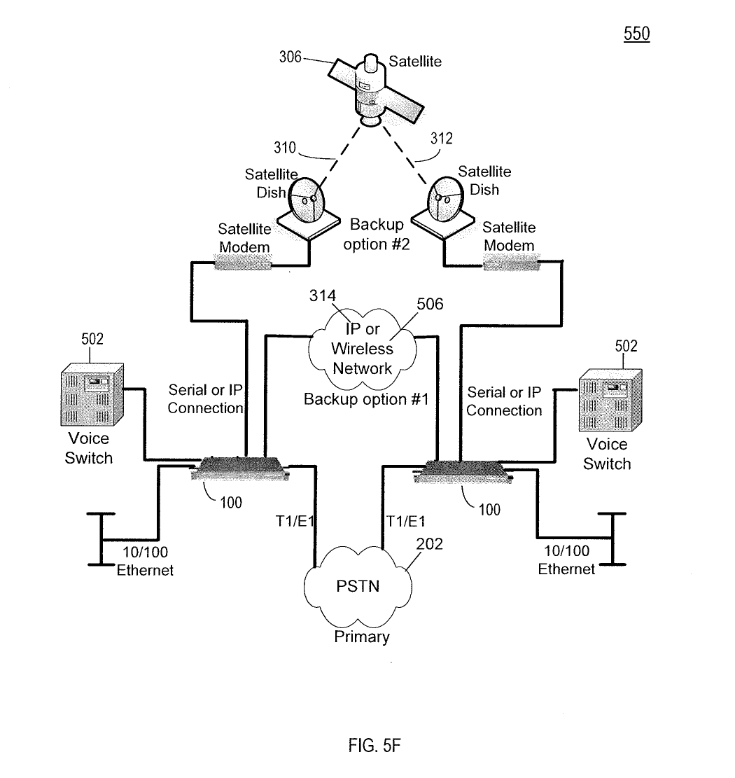

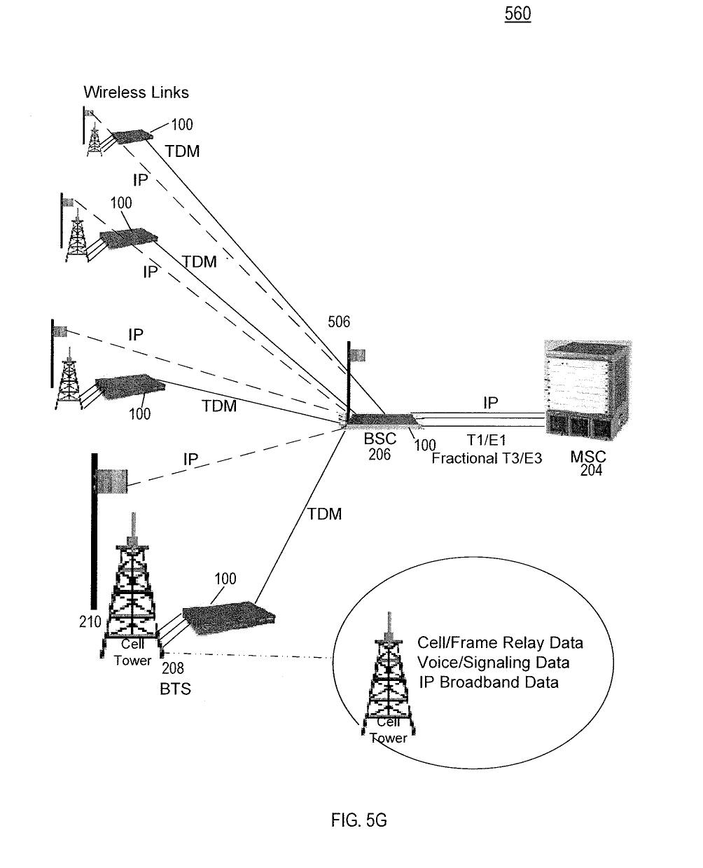

FIG. 5A depicts a diagram 500 illustrating one exemplary embodiment of the present invention using broadband wireless network 506 to replace a typical terrestrial T1 508a and 508b coupling or connecting devices such as, e.g., but not limited to either two PBXs 502a and 502b or two routers 504a and 504b. Replacing the existing T1 508 with device 100, this embodiment may provide a complete replacement for the traditional terrestrial T1 line. This embodiment may provide corporations or individuals enhanced functionality and lower costs with low risk.

FIG. 5B depicts a diagram 510 illustrating one exemplary embodiment of the present invention using broadband wireless 506 as a backup communications path for an existing terrestrial T1 connection 508a between two PBXs 502a and 502b. In this embodiment device 100 may be connected or coupled to the existing T1 and also may be connected or coupled to broadband wireless network 506. Device 100 may monitor the status of the T1 connection. If the T1 connection cannot handle the current traffic load (e.g., not enough bandwidth, dropped connection, etc.) device 100 may route traffic through the broadband wireless connection 506. This embodiment may provides backup for critical services, non-disruptive monitoring of the primary trunk, an alternate failover, and provisions for overflow traffic.

FIG. 5C depicts a diagram 520 illustrating one exemplary embodiment of device 100 using broadband wireless network 506 to replace the typical PSTN connection 202 between a PBX 502 and off premise extensions devices 522 (e.g., fax) and 524 (e.g., phone). In this embodiment, one device 100 maybe connected or coupled to a PBX 502 and a broadband wireless network 506. Communicating with device 100 through the wireless network 506 maybe another device 100 which may allow connected or coupled devices 522 and 524 to use off premise extensions. Device 100 may provide for off premise extensions which may bypass tolls and may allow mobility for devices 522 and 524. According to one embodiment functionality of user devices 522, 524 maybe limited, and or restricted, to prevent a user from distraction, in e.g., an environment where a user is in a critical occupation, driving a vehicle, etc.

FIG. 5D depicts a diagram 530 illustrating one exemplary embodiment of the present invention using broadband wireless 506 to replace an exemplary terrestrial T1 connection 508c between a PBX device 502 and a carrier switch device 532. In this embodiment, one device 100 may be connected or coupled to a PBX 502 and may communicate to another device 100 through the broadband wireless network 506. The other device 100 may be connected or coupled both to the wireless broadband network 506 and a carrier switch 532, located at the carrier location 534. Used in this fashion, device 100 may reduce carrier connection costs.

FIG. 5E depicts a diagram 540 illustrating one exemplary embodiment of the present invention using broadband wireless network 506 to replace connections or coupling made through exemplary PSTN or AMP networks 542. In this embodiment, one device 100 may be connected or coupled to a PBX device 502 and may communicate to another device 100 through the broadband wireless network 506. The other device 100 may be connected or coupled to, e.g., but not limited to, the broadband wireless network 506 and/or devices 522 and 524. Used in this fashion, device 100 may allow for the replacement of devices 522 and 524 that were using the outdated AMPS network 524. According to one embodiment, analog fax and telephony devices may be provided access over a broadband wireless network such as, e.g., but not limited to, the Sprint network available from Sprint Corp. of Kansas City, Mo. By restricting operation, or functionality for a user device to an analog end user, device 522, 524, a driver of e.g., a boat, a train, or a tug boat, may be prevented from, e.g., surfing the internet, or watching video, when the users should be doing the user's job but the user's device may be able to take advantage of the functionality of the broadband wireless network.

FIG. 5F depicts a diagram 550 illustrating providing exemplary automatic backup of PSTN links 202 using satellite 306, IP 314, or wireless connections 506, according exemplary embodiments.

FIG. 5G depicts a diagram 560 illustrating providing exemplary automatic backup of terrestrial links to wireless connections, according exemplary embodiments.

Automatic Voice and Data Fail-Over-Automatic Backup for T1/E1 Circuits Over IP or Satellite

According to one exemplary embodiment, as shown and described further with reference to FIGS. 5B and 5F, device 100 may automatically detect an outage in the network and may route traffic over a back up link. According to one exemplary embodiment, a device 100 may use advanced digital signal processing (DSP) voice compression—only 128 Kbps—to fully back up a T1, 192 Kbps to fully backup an E1. According to one exemplary embodiment, a device 100 may drop and insert capability to groom or back up selected DSOs of T1/E1 circuits. According to one exemplary embodiment, a device 100 may provide automatic TDM Clock regeneration at remote locations. According to one exemplary embodiment, a device 100 may further provide VPN security.

While terrestrial networks are vulnerable to outages due to natural or man-made disaster at any time, implementing automated backup for full or fractional T1/E1 voice/data circuits is an expensive proposition for most operators. However, using exemplary compression technology, according to one exemplary embodiment, a device 100 from Netrix available from NSGDatacom, Inc., toll quality voice can be maintained over low speed satellite, wireless, and IP networks. According to one exemplary embodiment, technology field proven by the US Military and used by major carriers, low bandwidth voice compression is now a viable backup to standard telephone T1/E1 PSTN and cellular backhaul connections. According to one exemplary embodiment, TDM timing and data clock can be recovered across IP or other packet based connections, even when long delays such as multiple satellite or wireless hops are present.

As an exemplary embodiment, the Netrix Network Exchange (Nx) 2200 product family from NSGDatacom offers operators a cost effective way to automatically monitor and backup critical T1/E1 voice/data circuits that may be subject to outage due to intermittent or catastrophic failure. In the event of failure, Nx2200 products automatically compress and route toll quality voice and data over an alternate network connections, and allow controlled redeployment to the primary link when it is re-established. This helps operators maintain customer service levels, and minimize potential revenue losses during unplanned network outages. More importantly, it can eliminate critical delays in re-establishing communications to an area suffering from hostile activity or natural disaster.

### Automatic Backup for T1/E1 Circuits Over IP or Satellite—Operational Description

Multiple types of connection may be configured to backup a T1/E1 link. These include IP packet-based transmission, or point-to-point serial transmission over terrestrial, microwave, satellite or wireless. As an exemplary embodiment, configuration of Nx2200 series products is totally symmetrical in that any type of link may be configured to backup any other type of link. These products also support a full digital cross connect at the DS0 level, and data aggregation functions such that multiple voice and data circuits may be combined for transmission over backup and/or primary packet-based or TDM networks.

For conventional PSTN voice circuits, individual voice channels may be compressed using toll quality voice compression to substantially reduce bandwidth usage. For additional bandwidth savings, multiple calls are combined using our proprietary SFTM trunking protocol over IP or other packet-based links, such that the each voice call uses as low as 4.8 Kbps of bandwidth while still maintaining toll quality voice fidelity. Optional silence suppression enables bandwidth to be reduced even further, to give 16:1 or greater total compression when there is nominally 50% silence. Comfort noise generated locally during periods of silence ensures users are not aware silence suppression is being used. Where bandwidth is not an issue, uncompressed T1 or E1 circuits may be transmitted over a packet connection with automated TDM clock recovery at the remote location where necessary.

For cellular backhaul and fractional T1/E1 circuits, unused DS0s are not transmitted, eliminating the need to reserve unnecessary bandwidth on high cost backup links. Data compression may be used to further compress fractional T1/E1 IP packet data.

### Automatic Fail-Over

In the event a network failure is detected, traffic can be automatically routed over one or more alternate connections. A range of parameters may be monitored on a T1/E1 link and soft thresholds selected for different alarm conditions to trigger automated fail-over to a backup connection. Parameters may be monitored for total loss of service or loss of path without loss of framing. As an example, when the problem is down stream of a sub-rate multiplexor that continues to generate correct framing without data. Fail-over can also be triggered as a result of service degradation due to an increasing error rate or frame alarms.

### Automatic Backup Over Wireless or Satellite

FIGS. 5F and 5G depict diagrams 550 and 560 showing how the exemplary Nx2205D devices 100 can provide automatic backup to the primary PSTN link 202 using, e.g., but not limited to, satellite 306, IP 314, or a wireless connection 506. FIG. 5G illustrates a BTS 208 coupled via a wireless TDM link to BSC 206, which may in turn be coupled to MSC 204.

Depending on the reason for fail-over, and the type of traffic on the link, it may be possible for calls in progress to be gracefully moved from an existing link to a new link as they are cleared down. As an exemplary embodiment, the Nx2200 series of products offer a sophisticated suite of network gateway functions for voice calls between different network types, such as Public Telephone Networks, Cellular and Voice over IP. In some cases during a complete network failure the Nx2200 series products can hold a call open at the endpoints and reconnect them over the backup link without customers even being aware that a catastrophic event has taken place.

### Automatic Restoration

Traffic can be automatically routed back over a primary link when it recovers, based on preprogrammed criteria. Some circuits may have to be backed up for “brownout” rather than complete failure. Since this condition results in frequent short duration outages, brownouts could cause a circuit to “bounce” between the primary and backup path, which would in turn cause repeated dropping of calls in progress. Recovery can be placed under manual control with information on link stability and operational statistics accessible to the operator in real time using, as an exemplary embodiment, the Netrix View Network Management System. Depending on the type of circuits in use, calls in progress may be gracefully moved from one active circuit to another with minimal noticeable impact on users.

As an exemplary embodiment, the Nx2200 series products can also be programmed to route across different network connections based on other criteria such as time of day, network loading, etc.

### Voice Compression

As an exemplary embodiment, the Nx2200 products utilize advanced Digital Signal Processing (DSP) voice compression techniques, which greatly exceed standard VoIP compression methods. For example, SIP systems cannot easily be used for efficient backup due to the high overhead and relatively low level of overall compression achieved. However, the award winning Netrix compression algorithms, which retain PSTN quality voice, require only 5.5 Kbps of bandwidth per voice call before silence suppression is enabled. Signaling channel data may be packetized and combined with other data for additional bandwidth savings. Local acknowledgements also minimize traffic sent over the link when there is no call activity. These bandwidth requirements translate to a high cost saving for the redundant path, such that many organizations now consider permanently provisioned backup circuits also viable for overflow traffic at peak utilization in addition to the back up function.

Wireless Backup for Terrestrial Links

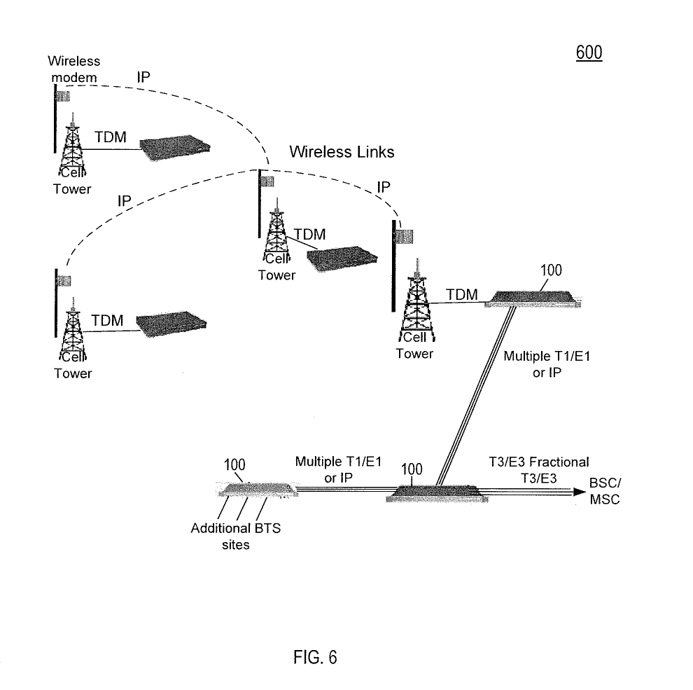

FIG. 6 shows terrestrial primary connections with wireless backup links using, as an exemplary embodiment, a single Nx2222 connecting multiple services at the BSC with Nx2205s, using the inherent digital TDM cross connect, IP routing, and aggregation functions of both products.

### Fractional Backup

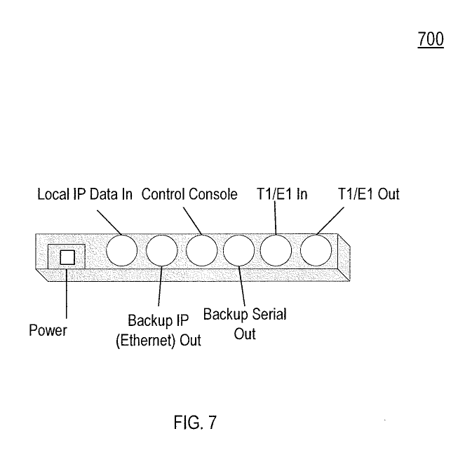

With fractional backup an operator can choose to protect only certain channels, or a certain number of channels within the T1/E1, thereby reducing the bandwidth required during backup. FIG. 7 diagram 700 demonstrates an exemplary embodiment as Nx2200 products allow a full or fractional T1 circuit to backup a full or fractional E1 circuit, or vice versa. Conversion between T1 and E1 is also possible through Nx2200 series products, with T1 clock generation possible from incoming packet based data, or from a terrestrial E1 circuit.

### Activity Logging and Alarms

Comprehensive activity logging guarantees that operators can check the quality and usage of both primary and backup path for SLA certification. Extensive remote Configuration, Monitoring and Alarm functions are provided, as an exemplary embodiment, by the Netrix View NMS system, along with a comprehensive suite of other Management and Diagnostic tools.

### TDM Clock Recovery

As an exemplary embodiment, Nx2200 products employ deep plesiosynchronous buffer systems, T1/E1 jitter attenuation and clock recovery mechanisms with configurable options to fine tune for the delay over an IP link. Depending on the type of link and the reliability of service, buffer depth may be set to accommodate a wide range of delay and/or varying transmission profiles such as terrestrial IP, wireless IP, satellite networks, or a combination of all these with multiple hops.

### Support for Wireless Back Up

FIG. 6 depicts a diagram 600 illustrating how exemplary Nx2200 series device 100 can create as needed a wireless IP mesh connections between locations with TDM clock recovery at the BTS, even with multiple wireless hops.

Operation over Satellite

As an exemplary embodiment, the Nx2200 device 100 are optimized for use with Satellite networks and operate seamlessly with DAMA systems where bandwidth is available from a pool on an as-needed basis. With Nx2200 series products installed at both ends of a terrestrial T1/E1 link, the satellite bandwidth required during normal operation is minimal. In the event of a terrestrial link failure the voice/data traffic is compressed and rerouted via a dedicated serial or Ethernet connection over the satellite link. The DAMA system automatically detects the increase in traffic and additional bandwidth is allocated to the satellite connection for as long as needed. When the primary T1/E1 connection is re-established, traffic may be manually routed back onto the primary connection or automatically switched based on pre-set parameters.

As an exemplary embodiment, the layout size and layout of the Nx2205D makes it easy to install and simple to connect into the network. The Nx2222 has similar ease of use, supporting up to 9 simultaneous T1/E1 through connections plus IP in a single 1 U high chassis.

As an exemplary embodiment, the Nx200, device 100, provide a proven, cost effective, and highly reliable solution for backing up your voice and/or data network, particularly suited to situations where there is a likelihood of intermittent or catastrophic failures in the network. The Nx2200, device 100, are optimized for operation over satellite networks but are equally effective for backing up T1/E1 voice/data links over low speed terrestrial, wireless or microwave networks.

VPN security is also available for protection of sensitive communications.

### Voice Compression Gateway for IP Services

The wide deployment of VoIP as an alternative to conventional telephony brings with it some unanticipated challenges for Service Providers when broadband IP access is not available. In small office environments multiple VoIP calls can quickly use up the majority of available bandwidth and also generate a large volume of IP packets. FIG. 5F diagram 550 illustrates an exemplary embodiment, the Netrix Network Exchange (Nx) 2205D VoIPZIP from NSGDatacom device 100, the throughput constraints are eliminated using voice compression and IP frame packing techniques.

As an exemplary embodiment, the Nx2205D VoIPZIP is an integrated VoIP compression gateway for SIP and MGCP. Simple to install at the customer premises, the VoIPZIP is configured to recognize all voice packets and compress them before onward transmission to the Service Provider. All other packets are forwarded over the network without being affected. A central site unit at the Service Provider's location reconstitutes the original voice packets. The VoIPZIP unit operates transparently to the user at all times.

For example, a typical T1 connection can support around 15 uncompressed VoIP calls (using 1.2 Mbps) with minimal bandwidth available for IP data. Using the exemplary VoIPZIP, 15 toll quality voice calls only utilizes approximately 130 Kbps of bandwidth, leaving over 90% of the T1 capacity still available for IP data or additional voice traffic. Alternative compression options including silence suppression can reduce the bandwidth required for voice by 16:1 or greater.

The exemplary VoIPZIP is designed for use over DSL or fractional T1/E1 links and also operates over wireless and satellite. Full network management provides full support for remote configuration, diagnosis and statistical call analysis. A range of VoIPZIP platforms are available for CPE and Central Office applications.

As an exemplary embodiment, the reputation of the Netrix Nx2200 device 100 for outstanding voice clarity is continued in the VoIPZIP. With many voice compression implementations there is a trade-off between voice quality and data throughput efficiency; improve one and you negatively impact the other. Not so with the exemplary Nx2200 series. Independent testing and extensive deployments have proven the VoIPZIP codecs to be indistinguishable from the PSTN. High quality vocoders are only just the start for high quality voice over a converged network. Sophisticated queue buffer, jitter buffer and echo cancellation mechanisms are deployed to maintain this quality, particularly over circuits with long delays. Here again the Netrix heritage shows. Netrix's experience in voice and data integration has resulted in the creation of unique, robust solutions to the problems inherent to using IP services over multiple wireless or satellite hops.

On the data network side, sophisticated traffic management capabilities preserve voice clarity without sacrificing bandwidth efficiency. IP overhead associated with multiple calls to a single destination is eliminated, thereby optimizing line utilization. Additionally, QoS mechanisms (TOS & DiffServ) ensure voice traffic is given the required priority over other data. A clock recovery mechanism allows TDM link timing to be retained over an IP connection.

Installed in many mission critical networks worldwide, Nx2200 device 100 continue to provide dependable voice and data transmission in call centers, military, transaction processing, financial, airport, service provider, and other enterprise applications.

### Physical Interfaces

LAN Connectivity

Two integrated switched Ethernet interfaces

Auto sensing,
10BaseT or 100BaseT
user or hub connection
independently on each Ethernet connection
RJ-45 physical interface

High Speed Serial Interface

One optional high-speed serial interface, internal or external clocking to 2.048 Mbps

Software configurable DTE/DCE, V.24/RS-232/V.35/RS-449/X.21
Speeds from 1200 bps to 2.048 Mbps

Optional Digital I/F

Two T1 or E1 voice and/or data

Full drop and insert for all DS0/timeslots between interfaces

CAS and ISDN fully supported

Transparent pass through for signaling including SS7

Transparent TDM clock recovery over IP

### Connectivity

Voice/Fax

CAS/ISDN/E&M

H.323, SIP, B2BUA, G.711, G.729a, CELP 4.8/7.4 kbps, ACELP 5.5/8.0 kbps

V.27 ter, V.29, Group III

IP

VoIP, MGCP, RIPv1/2, OSPF, Static Routing, SNMP, SFTM

H.323, SIP, B2BUA

Frame Relay

Frame Relay NNI, UNI, FRF4/ITU Q.933, Frame Relay Annex D, LMI

PVC and SVC support

### Management

Graphical User Interface (GUI) hosted by Microsoft Windows® PC.

Configuring, monitoring and troubleshooting over public, private or hybrid networks.

Distributed management of existing equipment via Simple Network Management Protocol (SNMP)

### General

Physical

Size: 17.25″W×10″D×1.75″H (43.8 W×25.4 D×4.5H cm)

Weight: 2.25-3.25 lbs (1.0 kg-1.5 kg)

Power: 100-240 VAC, 50-60 Hz 18 VA

Environmental

Temperature:

### Operating −32°-122° F. (0°-50° C.)

### Storage: 23°-158° F. (−5°-70° C.)

Humidity: 20-95% non-condensing

MTBF: >65,000 hours @ 86° F. (30° C.)

Approvals

Safety: UL, CSA, IEC 950, EN 60950 (73/23/EEC), CE Mark

Telecom: 91/263/EEC, EMC: FCC Part 15 Class A, VCCI Class 1

Immunity: 89/336/EEC

### Flexibility

From Five to Sixty compressed voice channels

Other Central Site models available

Supports Meshed Networks

High quality, low bandwidth compressed voice and data over IP or Frame Relay

All ports and channels are software configurable via the GUI

### VOIP Gateway Services

Internet standards and developments in VoIP technology have made the combination of voice and data—long treated as separate services—not just a good technical concept, but a sound business decision. As an exemplary embodiment, the Netrix Network Exchange (Nx) 2205D from NSGDatacom, managers now have the ability to add high quality digital voice services to a multi-service network, making such convergence a simple and affordable reality.

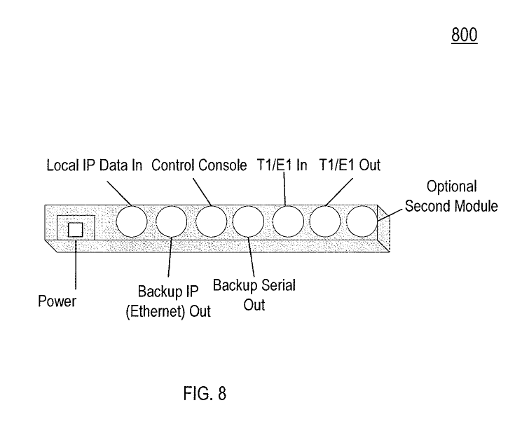

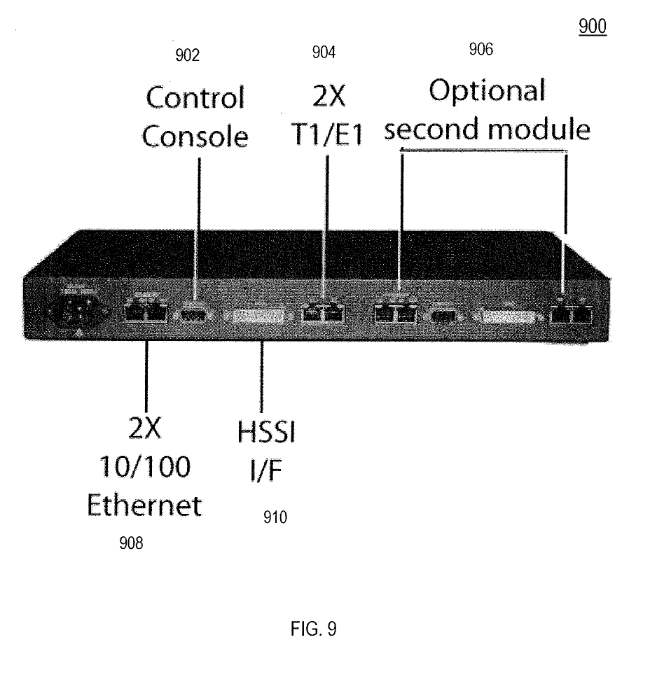

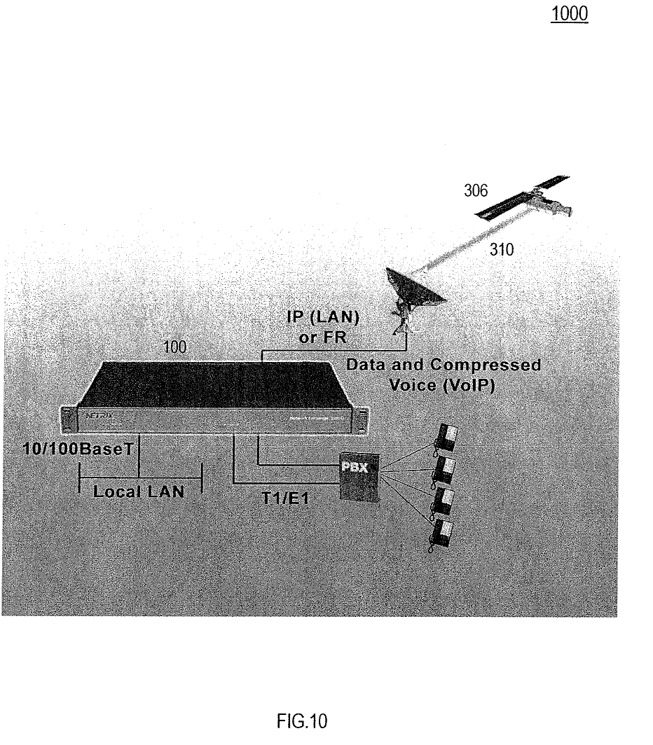

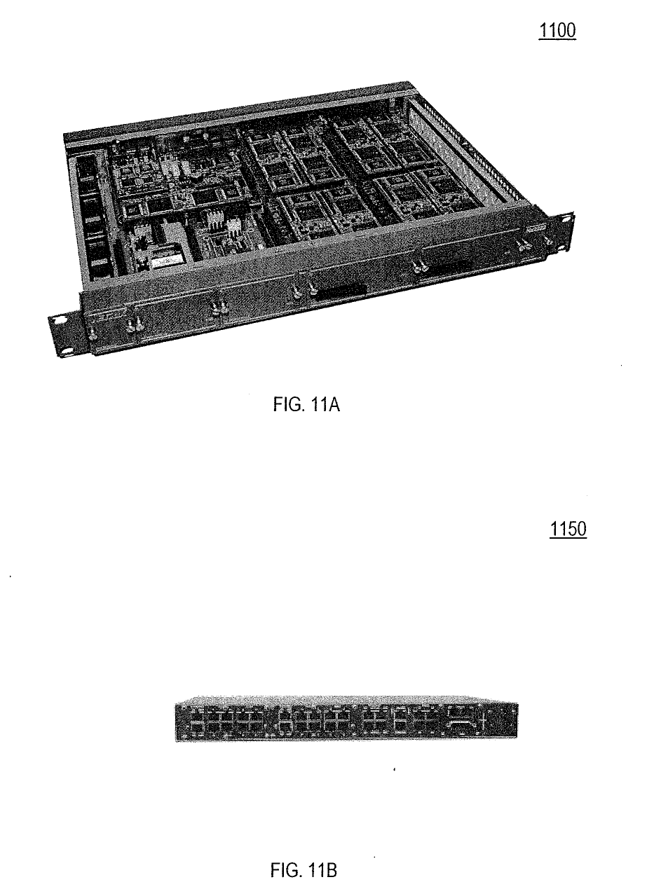

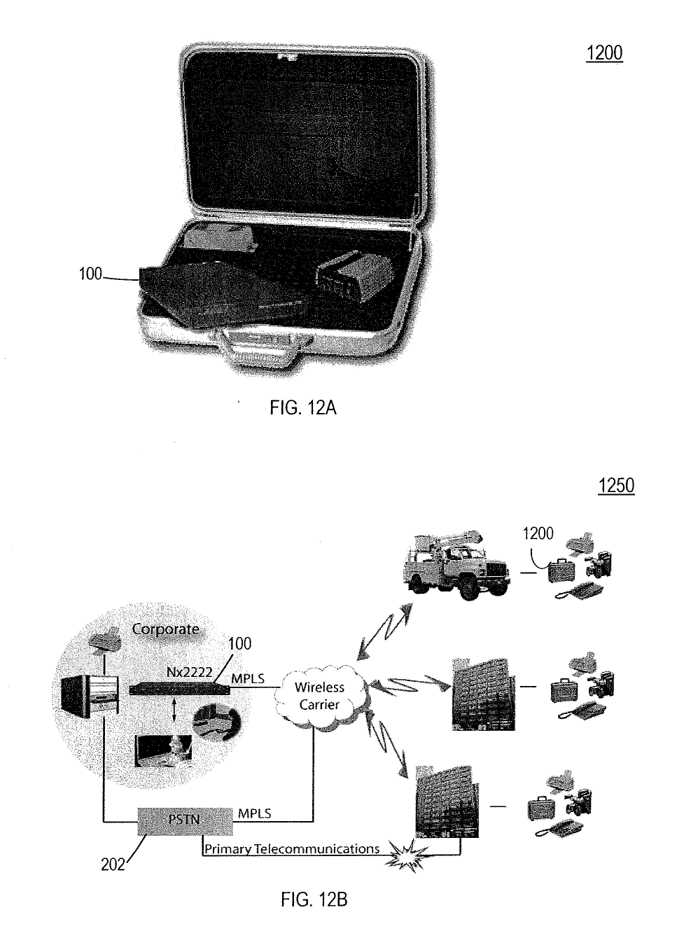

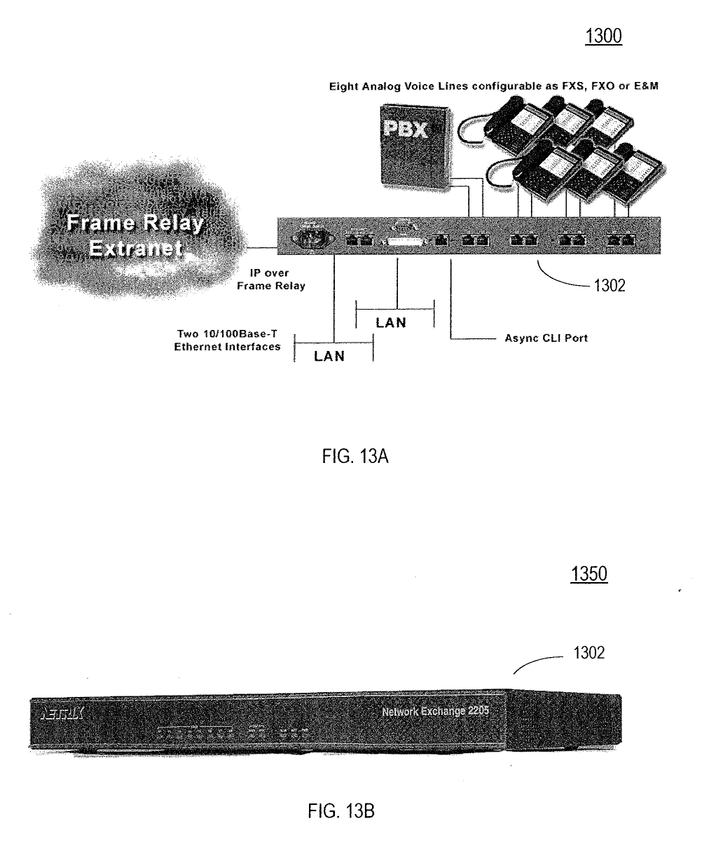

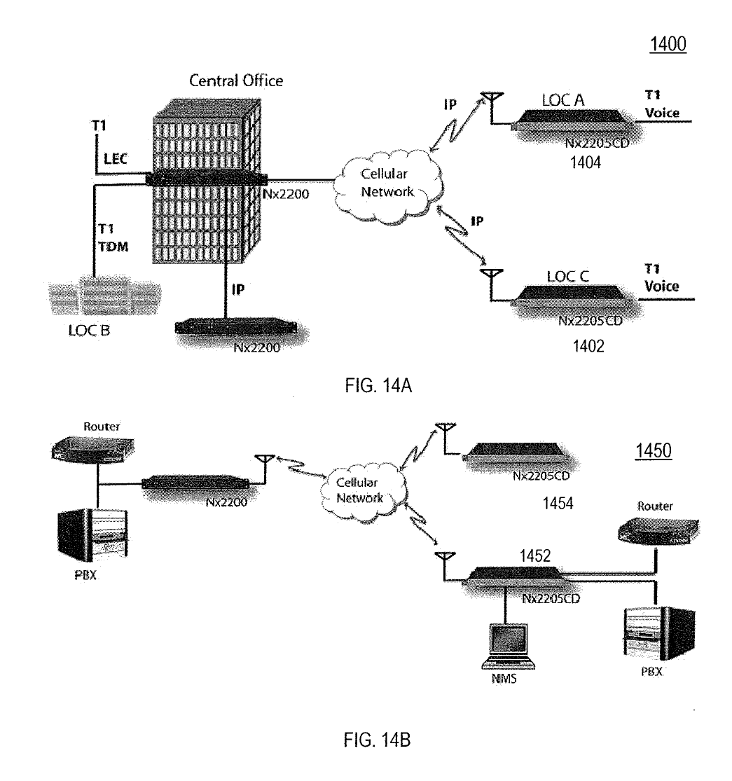

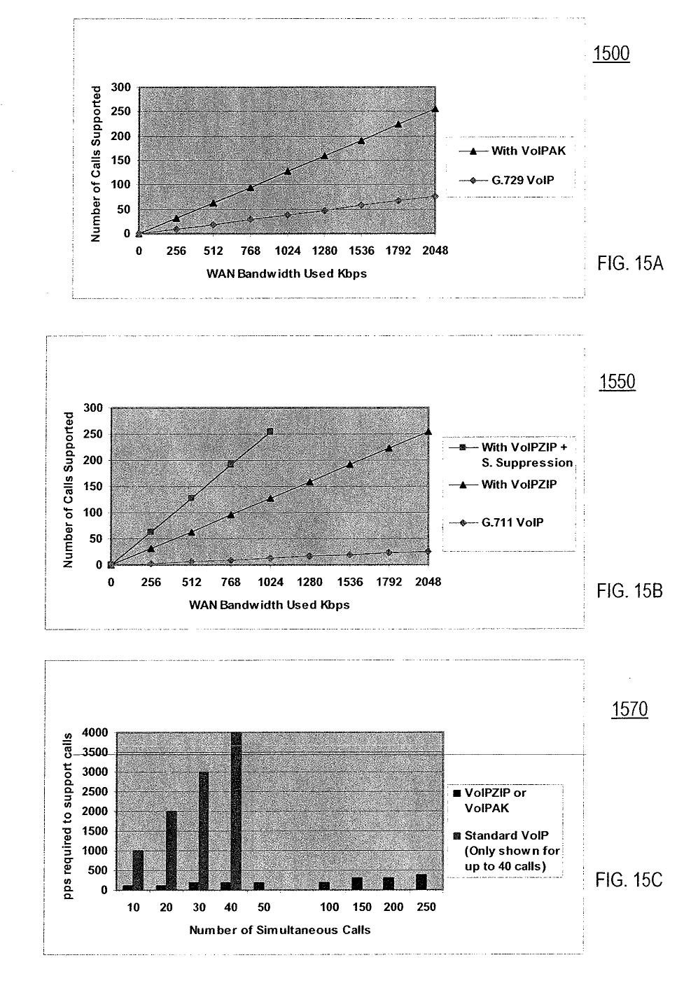

As an exemplary embodiment, the Nx2205D device 100, as shown in FIG. 8, is an integrated VoIP gateway and data access device for LAN and WAN applications. Full or fractional T1 or E1 voice circuits can be connected directly to the unit and individual voice channels compressed and merged with other data streams for transmission over public or private packet-based networks including Frame Relay or IP. Dual T1/E1 ports with a full DS0-level digital cross connect allows drop and insert on incoming and outgoing circuits, and the non-blocking ability to groom or mix G.711 voice circuits with fractional T1/E1 packet data. In an exemplary embodiment, device 100 can be connected to a local LAN and T1/E1, to send data and compressed voice (VoIP) over a network.

The reputation of the exemplary Netrix Nx2200 device 100 for outstanding voice clarity is continued in the Nx2205D. With many VoIP implementations there is a trade-off between voice quality and data throughput efficiency; improve one and you negatively impact the other. Not so with the Nx2205D, which combines the use of industry standards with proprietary compression techniques to ensure interoperability, toll quality voice and high bandwidth efficiency. Drawing from Netrix's heritage of nearly twenty years experience in voice and data integration, the Nx2205D eliminates the need to compromise voice quality when combining data and voice traffic over the same network.

As an exemplary embodiment, interoperability is a key element in the Nx2205D's design, which also conforms to H.323 and SIP, enabling integration with soft switches, PC-based telephony and other gateways. The Nx2205D's compression algorithms include the common standards along with Netrix-developed vocoders. Independent testing and extensive deployments have proven the Netrix 8 Kbps codec to be indistinguishable from the PSTN. High quality vocoders are only just the start for high quality voice over a converged network. In conjunction with its sister product the Nx2205A, sophisticated queue buffer, jitter buffer and echo cancellation mechanisms are deployed to maintain this quality, particularly over circuits with long delays. Here again the Netrix heritage shows. Netrix's experience in voice and data integration has resulted in the creation of unique, robust solutions to the problems inherent to using satellite services. The Nx2205 product family maintains toll quality connections over one or more satellite hops.

On the data network side, the exemplary Nx2205D's sophisticated traffic management capabilities preserve its bandwidth efficiency and voice clarity without sacrificing functionality. The system reduces the overhead associated with multiple calls to a single destination, thereby optimizing line utilization. Additionally, the Nx2205D uses QoS mechanisms (TOS & DiffServ) to ensure voice traffic is given the required priority. A clock recovery mechanism allows TDM link timing to be retained over a wireless or wireline IP connection.

Currently installed in many networks worldwide, the exemplary Nx2200 device 100 may be relied upon to provide critical voice and data transmission in call center, military, transaction processing, financial, airport, service provider, and many other mission critical enterprise applications.

### Physical Interfaces (Per Card)

Digital Voice

Two T1 or E1 voice and/or data

Up to thirty voice channels can be compressed

Full drop and insert for all DS0/timeslots between interfaces

CAS and ISDN fully supported

Transparent pass through for signaling including SS7

Transparent TDM clock recovery over IP

LAN Connectivity

Two integrated switched Ethernet interfaces

Auto sensing,

10BaseT or 100BaseT

user or hub connection

independently on each Ethernet connection

RJ-45 physical interface

High Speed Serial Interface

One optional high-speed serial interface, internal or external clocking to 2.048 Mbps

Software configurable DTE/DCE, V.24/RS-232/V.35/RS-449/X.21

Speeds from 1200 bps to 2.048 Mbps

### Connectivity

Voice/Fax

CAS/ISDN/E&M

H.323, SIP, B2BUA, G.711, G.729a, CELP 4.8/7.4 kbps, ACELP 5.5/8.0 kbps

V.27 ter, V.29, Group III

IP

VoIP, RIPv1/2, OSPF, Static Routing, SNMP, SFTM

H.323, SIP, B2BUA

Frame Relay

Frame Relay NNI, UNI, FRF4/ITU Q.933, Frame Relay Annex D, LMI

PVC and SVC support

Management

Graphical User Interface (GUI) hosted by Microsoft Windows® PC.

Configuring, monitoring and troubleshooting over public, private or hybrid networks.

Distributed management of existing equipment via Simple Network Management Protocol (SNMP)

### General (Up to Two Cards Fit in Chassis)

Physical

Size: 17.25″W×10″D×1.75″H (43.8 W×25.4 D×4.5H cm)

Weight: 2.25-3.25 lbs (1.0 kg-1.5 kg)

Power: 100-240 VAC, 50-60 Hz 18 VA

Environmental

Temperature:

### Operating −32°-122° F. (0°−50° C.)

### Storage: 23°-158° F. (−5°-70° C.)

Humidity: 20-95% non-condensing

MTBF: >65,000 hours @ 86° F. (30° C.)

Approvals

Safety: UL, CSA, IEC 950, EN 60950 (73/23/EEC), CE Mark

Telecom: 91/263/EEC, EMC: FCC Part 15 Class A, VCCI Class 1

Immunity: 89/336/EEC

Flexibility

Up to thirty voice channels

Full drop and insert

Voice and Data over IP

High quality, low bandwidth compressed voice over IP or Frame Relay

All ports and channels are software configurable via the GUI

### Bandwidth Optimization Router

An exemplary embodiment is shown in FIG. 6 the Nx2222, device 100, which is the latest in a line of Netrix high performance voice and data compression routers designed for aggregating and optimizing Cellular and PSTN backhaul links. Designed as a fully featured Telecom switching platform, the Nx2222 reduces network costs for operators by freeing capacity, making it available for increase revenue on existing services and enabling the introduction of new services.

Based on proven technology, the exemplary Nx2222 takes advantage of the latest generation hardware and advanced software to provide a highly integrated and scalable design. From 2 to 18 T1/E1 circuits of GSM Abis or Ater traffic, or up to 548 PSTN voice, facsimile or fractional data channels can be accommodated in a single 1 U high chassis.

With hot swappable line cards, redundancy and remote management support, the exemplary Nx2222 is designed for backhauling traditional or Cellular telephone traffic over leased line trunks or IP based connections such as wireless and satellite. The modular design of the Nx2222 allows it to easily scale to higher capacity networks.

The exemplary Nx2222 contains a DS0 digital cross connect, an IP router with gateway functions, Ethernet ports and high speed serial ports supported by the broad and extensively deployed Netrix suite of protocol optimization, switching and voice compression algorithms. Netrix voice compression supports standard VoIP with SIP as well as alternative low-rate, toll-quality compression used by the US military to achieve up to 16:1 bandwidth compression. Even on cellular traffic with pre-compressed voice, additional gains of 2:1 can be achieved.

The exemplary Nx2222 is remotely configurable using the Netrixview GUI management system and is packed with advanced features such as T1/E1 failure detection with Automatic Fail-over to an IP backup link, transparent TDM operation over IP with embedded clock recovery, and IP packet shaping. In satellite applications the Nx2222 supports both IP and serial connections for seamless use in SCPC and DAMA systems.

NSG has partnered with major satellite vendors to optimize bandwidth usage. Currently installed in many countries, the exemplary Nx2200 device 100 have provided reliable communications for critical US Carrier and Military voice and data services for over 10 years. Other widely deployed applications include call center, banking, transaction processing, air traffic control and service providers world-wide.

### Cellular Backhaul

As an exemplary embodiment, the Nx2222 is an integrated digital cross connect and compression gateway for Cellular Abis and Ater backhaul applications. Up to 18 full or fractional T1 or E1 voice/data circuits can be connected directly to the unit and individual DS0s compressed and merged for transmission over TDM, Frame or IP packet-based connections. Unused voice channels can be dynamically compressed to save bandwidth on terrestrial or satellite connections.

TDM clock recovery allows TDM circuits to be merged and/or transparently transmitted over IP satellite, wireless, or terrestrial links. This includes standards compliant clock regeneration and jitter buffering to synchronize remote locations to the central network.

The exemplary Nx2222 operates seamlessly with the exemplary Nx2205D backhaul optimization and access router. Any connection into the Nx2222 can be configured as a network trunk or access port.

### Disaster Recovery

As an exemplary embodiment, the Nx2222 provides a cost effective, manageable solution for backing up TDM network circuits, particularly suited to situations where complete failure of a circuit might cause catastrophic loss of emergency services. Unobtrusive circuitry allows the Nx2222 to monitor TDM links and if failure is detected to automatically “take over” the TDM circuit and route pre-determined traffic onto a designated backup link. In pass-through mode there is no delay through the unit and even complete power failure to the unit itself may not effect operation of the T1/E1 circuit being monitored.

As an exemplary embodiment, the Netrixview NMS allows remote configuration and control of the disaster recovery functions. A range of parameters of the TDM circuit are monitored with thresholds set to trigger either an alarm for manual intervention, or automatic fail-over to one or more backup connections. Once the primary link is restored traffic may be manually routed back onto the primary connection or automatically switched based on pre-set parameters.

Operation of the backup operation is optimized for operation over satellite or wireless networks but is equally effective for backing up T1/E1 voice/data links over low speed terrestrial networks.

VPN Security is Also Available for Protecting Sensitive Communications—PSTN Voice Compression

As an exemplary embodiment, the Nx2222 supports a mixture of both analog and digital PSTN voice connections with compression to a maximum of 28 analog voice ports or 18 digital (T1/E1) trunks per unit, with an overall maximum of 548 voice, facsimile or data (DS0) circuits per unit.

Analog voice ports can be configured for connection to a local PBX or to telephone handsets. The Netrix suite of compression algorithms provide up to 16:1 bandwidth savings with toll quality voice compression using silence suppression (with optional user comfort noise).

Our voice compression technology is used extensively by the military due to its high quality, low bandwidth utilization and includes fixed rate algorithms optimized for low bandwidth satellite networks. Sophisticated queue buffer, jitter buffer and echo cancellation mechanisms are deployed to maintain quality over circuits with long delays such as multiple satellite hops.

The Nx2222 operates seamlessly with the Nx2205A analog voice access router. Please see additional data sheets for further information on our extensive voice compression technology and options.

IP Gateway with Packet Shaping

As an exemplary embodiment, interoperability is a key element in the Nx2222 design, which also conforms to H.323 v2 and SIP (including B2BUA), enabling integration with soft switches and PC-based telephony. The Nx2222 provides comprehensive gateway functions that allow interfacing between different network services and types. For example, the Nx2222 can compress SIP traffic over satellite connections, simultaneously reducing the bandwidth used by a factor up to 16:1 and reducing the number of IP packets transmitted by a factor of 30:1 or more.

### Network Management

The Netrixview network management system provides extensive network operations, administration, and maintenance capabilities. Monitoring, configuration, and administration are accomplished via a color graphics interface, incorporating alarms and statistics with reporting capabilities. The inclusion of Netrix' Selectview™ multiple sub-network management allows services such as virtual private networks to be configured, enabling individual customers to have varying levels of security, management and control.

### Physical

As an exemplary embodiment, the Nx2222 is designed for rapid deployment and easy maintenance in Telecom environments. The base unit is 1 U high and 13 inches deep (plus cable support bar) and has mounting brackets with three positions for installing into a standard 19 inch rack. Dual redundant power supplies and processor line cards are hot swappable without disturbing network cabling.

The unit includes power failure relay contacts for an external alarm and can accept up to 7 other alarm inputs. Alarm inputs can be optionally converted to additional relay outputs controllable from the Netrixview management system.

Both AC and DC voltage supplies are available and can be mixed in a single chassis.

### Specifications

### Physical Interfaces

T1/E1 (0-18 ports)
ANSI T1.403, ITU G.703, ITU G.704, ITU G826, TR 62411, TR 54016
Framing: D4, ESF, or G.70×
Line Coding: AMI, B8ZS, HDB3
Physical: 4×RJ-48c
Selection by module for T1 or E1. Short or long haul, APS 1:1 and 1+1 functionality with revertive and non-revertive mod
BERT and loopback diagnostics, software enabled per line or per timeslot

High Speed Serial Interface (1-2 Ports)

EIA-232, EIA-442/449, EIA-530, ITU X.21, ITU V.35

Physical: Micro DB26

Handles N×56/64 kbps data rates up to 2.048 Mpbs

Analog Voice Ports (2 to 28 Ports}

FXS fixed (RJ11)

Optional FXS/FXO/E&M software configurable (RJ45)

2 PSTN lifeline connections

ALARM Port

Relay contacts power fail output alarm

7 contact input sensors

Optional 3 contact outputs (replaces 6 contact inputs)

Switched Ethernet 4-8 Ports)

ANSI T1.617 IEEE 802.3, 802.1p/Q

Physical: 4-8×RJ-45

Power over Ethernet (optional)

Autosensing 10/100 Mbps Switched Ethernet autosensing DI/DIX (auto-polarity)

Optional 10/100/1000 Mbps Gig Ethernet ports (up to 4 port

Software configurable switching characteristics, QoS and ToS characteristics

### General

Physical

Size: 16.6″W×9″D×1.75″H (IU height) (419.1 mm×228.6 mm×44.45 mm)

All physical interfaces are on one side to ease cable management in tight confines

Power

30 watts maximum draw

+/−20 vDC to +/−65 vDC, 1.5 amps max

+/−90 vAC to =/−265 vAC, 50-60 Hz, 0.030 amps max

Optional PSU redundancy (with load sharing)

Optional 110 vAC/220 vAC external converter

Console Port

RS-232

Physical: RJ-45

Autosensing Async serial at data rates from 2.4 kbps to 230 kbps, serial settings 8N1 or 7E2, autosensing DTE or DCE mode (auto-polarity)

MTBF

>65,000 hours @+45C

Environmental

Temperature:

### Operating −4° to +149° F. (−20° to +65° C.)

Humidity: 0-95% non-condensing

Safety

FCC 47 CFR part 68,

IC CS-03,

IEC 950,

EN 60950,

ANSI/UL 60950-1-2002,

CAN/CSA-C22.2 No. 50950-1-03,

Telecordia GR-63,

Telecordia GR-1089

Other

Telecordia GR-1244,

Telecordia GR-3108 (OSP, 07-2004)

Optional Accessories

Console Port Adaptor

DB-9 to RJ-45 converter

Allows the operator to use a standard Ethernet cable to connect to the console port

Rack Mounts

Mounting ears for 19″ or 23″ open frame telco racks or enclosed equipment cabinets

Front mount, center mount and rear mount options available. Kit includes mounting ears, screws, and instructions

Cable support bar

Wall Mounts

Mounting brackets for perpendicular or parallel wall mount. Kit includes mounting ears, screws, and instructions

### Management

SNMP, SNMPv2, Telnet CLI, SSH CLI, serial CLI, Web browser (HTML, SHTML)

### Cellular Analog Voice/Data Access Recovery and Backup

A growing concern faced by all telecommunications users today is how to cope with disruption to critical services. As an exemplary embodiment, NSGDatacom's exemplary NxCAS, a self-contained mobile recovery and backup communications center supporting e.g., voice, facsimile (Fax) and data transmission from a hardened case. The NxCAS allows corporations, utilities, first responders and similar organizations to strategically locate portable units throughout the continental U.S. ready for deployment at a moments notice. With the NxCAS, telecommunications services can be established at an isolated location within minutes of its arrival.

Establishing rapid communications after a catastrophic event is one of the challenges faced by emergency services and utilities. Upon arrival in the disaster area, the exemplary NxCAS is cable-ready for connection to standard handsets, Fax machines and portable PC's, to establish telephone, Fax and data service. The NxCAS can be powered from either a 12-24V DC battery, or a local 110-220V AC power source. It operates over a variety of different 3G Cellular wireless data services using the cellular carrier of your choice.

The exemplary NxCAS is also ideal for outside crews arriving to perform routine maintenance tasks. It can be pre-configured to operate seamlessly with internal IT systems and mitigates the potential of contractors connecting non-qualified equipment to internal IT and communications systems. It is ideal for providing temporary communications in remote areas and in moving vehicles.

The exemplary NxCAS provides a complete cellular data end-user solution for recovery and backup situations, with 2 ports of telephone/Fax, two switched Ethernet ports for IP applications and an optional serial data port. Each unit can operate independently and also includes extensive remote management capabilities that can be centrally coordinated using the NetrixView GUI-based, Network Management Software included with every system.

The exemplary NxCAS is a true voice and data device, with sophisticated voice QoS mechanisms and supports all proprietary key systems and PBX signaling systems with no loss in end-to-end functionality. It interoperates with the extensive range of Nx voice and data solutions, including our widely deployed high capacity Analog and Digital trunk products.

In its basic configuration, the exemplary NxCAS voice ports can be connected to handsets and/or Fax machines (Fixed FXS). Optionally, software configurable analog ports (FXS, FXO and E&M modes) can be provided to allow connection directly to a local PBX or external data modems. Higher capacity units supporting additional analog and digital voice circuits are also available.

### Physical Interfaces

Analog Voice

Two analog voice interfaces

Fixed two-wire FXS loop start or two-wire FXO loop/ground start

Optional soft configurable two-wire FXS loop start, two-wire FXO loop/ground start and two/four-wire E&M.

Signaling types include Wink start, delay dial, immediate start, hoot-and-holler

Dialing can be either DTMF or pulse

LAN Connectivity

Two integrated switched Ethernet interfaces

Auto sensing,

10BaseT or 100BaseT

user or hub connection

independently on each Ethernet connection

RJ-45 physical interface

High Speed Serial Interface

One optional high-speed serial interface, internal or external clocking to 2.048 Mbps

Software configurable

Supports V.24/RS-232/V.35/RS-449, X.21 physical level

Speeds from 1200 bps to 2.048 Mbps

Async Serial Interface

V.24 9600 bps Console Port

### Connectivity

Voice/Fax

FXS/FXO/E&M

H.323, SIP, B2BUA, G.711, G.729a, CELP 4.8/7.4 kbps, ACELP 5.5/8.0 kbps

V.27 ter, V.29, Group III

DTMF or Pulse (10 or 20 pps)

IP

VoIP, RIPv1/2, OSPF, Static Routing, SNMP, SFTM

H.323, SIP, B2BUA

### General

Physical

4″ Gun Metal Computer Case

Dimensions: 11.3″×16.5″×4″

Weight: 12.7 lbs

Environmental

Temperature:

### Operating −32°-122° F. (0°-50° C.)

### Storage: 23°-158° F. (−5°-70° C.)

Humidity: 20-95% non-condensing

MTBF: >65,000 hours @ 86° F. (30° C.)

Approvals

Safety: UL, CSA, IEC 950, EN 60950 (73/23/EEC), CE Mark

Telecom: 91/263/EEC, EMC: FCC Part 15 Class A, VCCI Class 1

Immunity: 89/336/EEC

### EV-DO

Radio Features

EV-DO Rev. A with Fallback to EV-DO Rev. 0 and CDMA 1× (not recommended for CDMA 1×)

Dual-Band Support (800 MHz cellular and 1900 MHz PCS)

Certification

Class 1 Div 2, Parts A, B, C, & D

HSDPA

Radio Features

HSDPA with Fallback to UMTS, EDGE and GPRS (not recommended for GPRS)

Dual-Band UMTS/HSDPA (850 MHz and 1900 MHz)

Certification

Class 1 Div 2, Parts A, B, C, & D

### Voice and Data Gateway for IP Services

Internet standards and developments in VoIP technology have made the combination of voice and data—long treated as separate services—not just a good technical concept, but a sound business decision. As an exemplary embodiment, the Netrix Network Exchange (Nx) 2205A from NSGDatacom, managers now have the ability to add high quality voice to a multi-service network, making convergence a simple and affordable reality.

FIG. 5F depicts an exemplary Nx2205A device 100 as an integrated VoIP gateway and data access device for LAN and WAN applications. Analog voice circuits can be connected directly to the unit and merged with other data streams, enabling the realization of benefits previously available only to those willing to make major compromises. One such compromise is between voice clarity and bandwidth efficiency. With many VoIP implementations there is a trade-off between quality and efficiency; improve one and you negatively impact the other. Not so with the Nx2205A, which combines the use of industry standards with proprietary compression techniques to ensue interoperability, toll quality voice and high bandwidth efficiency. Drawing from Netrix's heritage of nearly twenty years experience in voice and data integration, the Nx2205A eliminates the need to compromise voice quality when combining data and voice traffic over the same network.

The exemplary Nx2205A's compression algorithms include the common standards along with Netrix-developed codecs. Independent testing proved the Netrix 8 Kbps codec to be indistinguishable from the PSTN. High quality voice codecs are only just the start for high quality voice over a converged network. Sophisticated queue buffer, jitter buffer and echo cancellation mechanisms need to be deployed to maintain this quality. Here again the Netrix heritage shows. Netrix's experience in voice and data integration has resulted in the creation of unique, robust solutions to the problems inherent to using satellite services. The Nx2200 product family maintains toll quality connections over one or more satellite hops.

On the network side, the exemplary Nx2205A's sophisticated traffic management capabilities preserve its bandwidth efficiency and voice clarity without sacrificing functionality. The system reduces the overhead associated with multiple calls to a single destination, thus optimizing line utilization. Additionally, the Nx2205A uses QoS mechanisms (TOS & DiffServ) to ensure voice traffic is given the required priority. Interoperability is another key element in the Nx2205A's design. It conforms to H.323 v2 and SIP, enabling integration with soft switches, PC-based telephony and other gateways.

The exemplary Nx2205A is a member of the extensive NSGDatacom range of products that are used worldwide for network solutions that scale from low-speed traffic to high-speed, ATM services.

### Physical Interfaces

Analog Voice

Two, Four or Eight analog voice interfaces

Fixed two-wire FXS loop start or two-wire FXO loop/ground start

Optional soft configurable two-wire FXS loop start, two-wire FXO loop/ground start and two/four-wire E&M.

Signaling types include Wink start, delay dial, immediate start, hoot-and-holler and phone

Dialing can be either DTMF or pulse

LAN Connectivity

Two integrated switched Ethernet interfaces

Auto sensing,

10BaseT or 100BaseT

user or hub connection

independently on each Ethernet connection

RJ-45 physical interface

High Speed Serial Interface

One optional high-speed serial interface, internal or external clocking to 2.048 Mbps

Software configurable

Supports V.24/RS-232/V.35/RS-449, X.21 physical level

Speeds from 1200 bps to 2.048 Mbps

Async Serial Interface

V.24 9600 bps Console Port

### Connectivity

Voice/Fax

FXS/FXO/E&M

H.323, SIP, B2BUA, G.711, G.729a, CELP 4.8/7.4 kbps, ACELP 5.5/8.0 kbps

V.27 ter, V.29, Group III

DTMF or Pulse (10 or 20 pps)

IP

VoIP, RIPv1/2, OSPF, Static Routing, SNMP, SFTM

H.323, SIP, B2BUA

Frame Relay

Frame Relay NNI, UNI, FRF4/ITU Q.933, Frame Relay Annex D, LMI

PVC and SVC support

### Management

Graphical User Interface (GUI) hosted by Microsoft Windows® PC.

Configuring, monitoring and troubleshooting over public, private or hybrid networks.

Distributed management of existing equipment via Simple Network Management Protocol (SNMP)

### General

Physical

Size: 17.25″W×10″D×1.75″H (43.8 W×25.4 D×4.5H cm)

Weight: 2.25-3.25 lbs (1.0 kg-1.5 kg)

Power: 100-240 VAC, 50-60 Hz 18 VA

Environmental

Temperature:

### Operating −32°-122° F. (0°-50° C.)

### Storage: 23°-158° F. (−5°-70° C.)

Humidity: 20-95% non-condensing

MTBF: >65,000 hours @ 86° F. (30° C.)

Approvals

Safety: UL, CSA, IEC 950, EN 60950 (73/23/EEC), CE Mark

Telecom: 91/263/EEC, EMC: FCC Part 15 Class A, VCCI Class 1

Immunity: 89/336/EEC

Flexibility

Up to Eight voice channels

High quality, low bandwidth compressed voice over IP or Frame Relay

Ports are software configurable via the Network Management System

### T1/E1 Cellular Access to a Local Exchange

Cellular T1/E1 Voice and Data Access

Primary or Backup T1/E1 over Cellular Wireless Data Services

Reduces T1/E1 costs by up to 75%

EV-DO Rev A. and HSDPA

Compatible with most Cellular Operators

SNMP Alarms

Dynamically allocates bandwidth with voice prioritization

Voice, Fax, Data, and PBX Signaling Supported

Carriers
AT&T
Sprint
Verizon Wireless
Alltel
Bell Mobility
Dobson
Rogers
Telus

The delivery time for installing traditional leased T1/E1 circuits is usually months and the operational cost is expensive. As an exemplary embodiment, the Nx2205CD uses a cellular wireless connection to provide the same level of service with significantly less installation time and at a greatly reduced cost.

FIGS. 5F and 5G depict diagram 550 and 560 illustrating exemplary Nx2205CD device 100 as an integrated voice and data access router for cellular wireless applications. A Digital T1 or E1 voice circuit connected directly to the unit is compressed using toll quality voice compression and merged with other data streams for transmission over the cellular connection. The widely deployed proprietary Netrix compression algorithms maintain voice quality indistinguishable from the PSTN, while reducing the bandwidth required for a full T1 to only 200 Kbps, and a full E1 to only 256 Kbps. Dynamic bandwidth allocation allows all unused bandwidth to be available for data.

The exemplary Nx2205CD is a true voice and data device supporting all proprietary PBX signaling systems end-to-end with no loss of functionality, and requiring no reconfiguration of the attached switches. Any time slot can carry the signaling information such as CAS/CSS. Out-of-band signaling is also supported. Fractional T1/E1s are supported along with SS7.

On the network side, the exemplary Nx2205CD's sophisticated traffic management capabilities preserve bandwidth efficiency and voice clarity without sacrificing functionality. Unlike many standards-based systems, the Nx2205CD reduces packet overhead associated with multiple calls to a common destination, thus optimizing line utilization. Additionally, the Nx2205CD uses QoS mechanisms (TOS & DiffServ) to ensure voice traffic is given the required priority.

The exemplary Nx2205CD is a member of the extensive NSGDatacom range of products used worldwide for network solutions that scale from low-speed traffic to high-speed, ATM services. For applications utilizing a large number of T1/E1s at a central site the Nx2205CD interoperates with other Nx2200 series products. Both are fully manageable from the sophisticated GUI-based NetrixView Network Management System.

### VoIP Network Optimization

As an exemplary embodiment, VoIP Network Optimization is a packet optimizer that reduces the packet overhead associated with multiple VoIP calls traversing common network connections.

As an exemplary embodiment, VoIPAK combines the packet streams from multiple VoIP calls into a single packet stream, typically reducing the number of network packets per second (pps) by a factor of 50:1 or more, and reducing the bandwidth required for trunking calls over common network connections by up to 3:1.

For Example, VoIPAK can reduce the typical network load of 50 simultaneous VoIP calls from 5000 pps to only 100 pps. Since only one voice sample from each call is placed in each packet no noticeable delay is added to any of the calls being transported.

By this means the exemplary VoIPAK also eliminates the significant IP overhead normally associated with VoIP calls. In the above example the total IP bandwidth required to support 50 G.729 VoIP calls is reduced from approximately 1.64 Mbps in each direction to less than 450 Kbps in each direction, a resulting bandwidth reduction of over 70%.

Note that the exemplary VoIPAK does not negatively impact the audio quality of the VoIP calls because the audio payload is transported in its entirety across the network. In fact the audio quality is normally improved substantially due to a significant reduction in network related packet loss when using VoIPAK. VoIPAK units works in both point to point and fully meshed modes and operate transparently to users at all times.

As an exemplary embodiment, VoIPZIP provides all the functionality of VoIPAK and also compresses the voice payload of G.711 VoIP calls using one of several optional compression formats. VoIPZIP eliminates the considerable throughput bottlenecks often associated with trunking uncompressed (G.711) VoIP calls over conventional wireline, satellite or wireless network connections.

For example, most service providers find that a single 1.544 Mbps (T1) data connection typically supports no more than 15 standard G.711 based VoIP calls before call quality is compromised. 15 standard uncompressed VoIP calls use 1.2 Mbps of bandwidth in each direction and generate 1500 pps. Using the packet optimizing techniques of the exemplary VoIPAK, the packet rate generated by 15 VoIP G.711 voice calls is reduced from 1500 pps to 100 pps. However, due to the uncompressed voice content, the G.711 based audio still uses approximately 970 Kbps of bandwidth in both directions.

With the additional voice compression capabilities of the exemplary VoIPZIP the audio content of G.711 VoIP packets is compressed using one of our standards-based compression engines. The resulting bandwidth required to support 15 toll quality voice calls (typical MOS of 3.9) is only 130 Kbps in each direction. The optional use of silence suppression reduces the required bandwidth by a further 40%-50%, to 80 Kbps or less, resulting in a total bandwidth saving in excess of 90%. With our optional low bit rate compression (typical MOS 3.7/3.8) a bandwidth reduction of 16:1 can be achieved.

As an exemplary embodiment, VoIPAK and VoIPZIP are highly flexible, configurable networking platforms with many additional benefits and optimization features not covered by this application note. Optional integrated WAN ports provide additional performance benefits over Ethernet connections. Graphical performance examples shown overleaf are typical for IP and can be exceeded in some applications.

As an exemplary embodiment, VoIPAK and VoIPZIP are designed for use in Carrier grade networks and are fully supported by the NetrixView Network Management System. The NMS interface provides comprehensive GUI support for remote configuration, diagnosis, statistical call analysis and other management functions. A range of VoIPAK and VoIPZIP platforms are available for CPE and Central Office applications which are fully interoperable with other products in the Netrix Network Exchange product line.

As an exemplary embodiment, Netrix brand products are Installed in many mission critical networks worldwide, and continue to provide dependable voice and data transmission in carrier networks, call centers, military, transaction processing, financial, airport, service provider, and other enterprise applications.

As an exemplary embodiment, VoIPAK increases the number of G.729 (and other low rate codec) based VoIP calls supported on a network connection by reducing IP packet overhead.

Example: Using VoIPAK bandwidth utilization is improved by a factor of 3.3:1.

Note: G.729 curve does not show any VoIP saturation due to high packet throughput which could cause VoIP calls to be limited, further enhancing the value of VoIPAK In this example.

Assumptions:

G.729 Sample size 20 Bytes (default)

IP (UDP/RTP) Headers 40 Bytes

MLPPP or Frame Relay Header 6 Bytes

VoIPZIP increases the number of G.711 based VoIP calls supported on a network link by compressing voice content and reducing IP packet overhead.

Example: Using VoIPZIP, bandwidth utilization is improved by a factor of 10:1 without silence suppression, and 20:1 with silence suppression.

Assumptions:

G.711 Compressed to 8 Kbps voice.

Silence suppression assumes 50% silence in each direction.

In the above Graphs WAN Bandwidth Used is full duplex, actual transmitted data in both directions.

VoIPAK and VoIPZIP can typically reduce the rate of VoIP network packets by a factor between 30:1 and 70:1 depending on the platform and its configuration.

Assumptions:

Sample rate is 20 ms, (50 pps each way).

pps shown is total sum of inbound and outbound packets.

Multiple input packets from a single VoIP call can be in the same output packet for greater packet efficiency (not illustrated).

VoIPZIP output sample rate can be configured independently of the input packet rate when compressing G.711 VoIP.

The exemplary embodiments provide an apparatus, method and computer program product to provide automated backup to a primary network. In exemplary embodiments, the primary network is a time division multiplexing (TDM) based network, and the backup network is an Internet Protocol (IP) based network. The backup connection may be used to restore the entire connection or a partial connection and to provide necessary or desired backup. As one example, the backup connection may be used to ensure continuity of emergency services, such as 911 services in the United States, from cell towers or other locations in the event of a network failure, or any other telecommunications based problems.

### CONCLUSION

Although the invention is described in terms of this example environment, it is important to note that description in these terms is provided for purposes of illustration only. It is not intended that the invention be limited to this example environment or to the precise inter-operations between the above-noted entities and devices. In fact, after reading the following description, it will become apparent to a person skilled in the relevant art how to implement the invention in alternative environments.

What is claimed is:

1. An adaptive telecommunications system for transporting communication traffic over a network comprising:
means for transmitting communication traffic between a plurality of devices through a network;
means for monitoring said communication traffic between said plurality of devices; and
means for adaptively changing a mode of operation of the system at least one of before or during a call, based on at least one of instantaneous network changes, connection type characteristics, or a type of said communication traffic.

2. The system of claim 1, wherein said devices comprises at least one of:
a fax;
an analog fax;
a digital fax;
a phone;
an analog phone;
a digital phone;
a mobile phone;
a router;
a computer;
a private branch exchange (PBX);
a switch;
a telephony switch; or
a communications device.

3. The system of claim 1, wherein said type of said communication traffic comprises at least one of:
fax;
video;
voice over internet protocol (VoIP);
voice; or
data.

4. The system of claim 1, wherein said network comprises at least one of:
wireless;
wired;
cable TV (CATV);
microwave;
telephony;
public switched telephone network (PSTN);
analog mobile phone service (AMPS);
terrestrial; or
satellite.

5. The system of claim 1, wherein said connection type characteristics comprises at least one of:
cellular;
satellite;
terrestrial;
error prone; or
delayed.

6. The system of claim 1, wherein said instantaneous network changes comprises at least one of:
traffic load;
error rate;
number of calls in progress; or
time of day.

7. The system of claim 1, further comprising means for restricting or compressing based on said type of said communication traffic content.

8. The system for claim 1, wherein said system comprises means for providing at least one of: providing overflow capacity or providing a replacement for fixed PSTN circuits.

9. The system of claim 1, wherein a quality of service (QoS) of said network is maintained based on at least one of said connection type characteristics, said type of said communication traffic, or said instantaneous network changes.

10. The system of claim 1, wherein said mode of operation comprises means for applying compression when a threshold number of calls in progress is met.

11. The system of claim 1, wherein said mode of operation comprises means for providing no compression when the number of calls drops below a specified threshold.

12. The system of claim 1, wherein said mode of operation comprises means for using a different compression algorithm for each of a transmit and a receive direction on the same call.

13. The system of claim 12, wherein compression only occurs in a direction towards a first device, with no compression from the first device to others of said plurality of devices.

14. The system of claim 1, wherein said type of said communication traffic comprises multiple VoIP traffic streams, said system combines said multiple VoIP packet streams into a single packet stream.

15. The system of claim 14, wherein in said VoIP traffic stream, uncompressed voice samples are compressed before combining said VoIP packet streams into said single packet stream.

16. The system of claim 15, wherein the said VoIP voice samples are analyzed and silence is suppressed.

17. An adaptive telecommunications method for transporting communication traffic over a network comprising:
transmitting communication traffic between a plurality of devices through a network;
monitoring said communication traffic between said plurality of devices; and
adaptively changing a mode of operation of the method at least one of before or during a call, based on at least one of instantaneous network changes, connection type characteristics, or a type of said communication traffic.

18. The method of claim 17, wherein said devices comprises at least one of:
a fax;
an analog fax;
a digital fax;
a phone;
an analog phone;
a digital phone;
a mobile phone;
a router;
a computer;
a private branch exchange (PBX);
a switch;
a telephony switch; or
a communications device.

19. The method of claim 17, wherein said type of said communication traffic comprises at least one of:
fax;
video;
voice over internet protocol (VoIP);
voice; or
data.

20. The method of claim 17, wherein said network comprises at least one of:
wireless;
wired;
cable TV (CATV);
microwave;
telephony;
public switched telephone network (PSTN);
analog mobile phone service (AMPS);
terrestrial; or
satellite.

21. The method of claim 17, wherein said connection type characteristics comprises at least one of:
cellular;
satellite;
terrestrial;
error prone; or
delayed.

22. The method of claim 17, wherein said instantaneous network changes comprises at least one of:
traffic load;
error rate;
number of calls in progress; or
time of day.

23. The method of claim 17, wherein the method comprises restricting or compressing based on said type of said communication traffic content.

24. The method of claim 17, wherein the method comprises providing at least one of: providing overflow capacity or providing a replacement for fixed PSTN circuits.

25. The method of claim 17, wherein a quality of service (QoS) of said network is maintained based on at least one of said connection type characteristics, said type of said communication traffic, and said instantaneous network changes.

26. The method of claim 17, wherein said mode of operation comprises a compression technique applied when a threshold number of calls in progress is met.

27. The method of claim 17, wherein said mode of operation comprises no compression when the number of calls drops below a specified threshold.

28. The method of claim 17, wherein said mode of operation comprises using a different compression algorithm for each of a transmit and a receive direction on the same call.

29. The method of claim 28, wherein compression only occurs in a direction towards a first device, with no compression from the first device to others of said plurality of devices.

30. The method of claim 17, wherein said type of said communication traffic comprises multiple voice over internet protocol (VoIP) traffic streams, said system combines said multiple VoIP packet streams into a single packet stream.

31. The method of claim 30, wherein in said VoIP traffic stream, the uncompressed voice samples are compressed before combining said VoIP packet streams into said single packet stream.

32. The method of claim 31, wherein the said VoIP voice samples are analyzed and silence is suppressed.

33. A machine-readable medium that provides instructions, which when executed by a computing platform, causes said computing platform to perform operations comprising a method for traffic type adaptive operation, the method comprising:
transmitting communication traffic between a plurality of devices through a network;
monitoring said communication traffic between said plurality of devices; and
adaptively changing the mode of operation at least one of before or during a call, based on at least one instantaneous network changes, connection type characteristics, or a type of said communication traffic.
